(19) United States
(12) Patent Application Publication
(10) Pub. No.: US 2026/0300851 A1
(43) Pub. Date: Oct. 1, 2026

(54) MULTI-STAGE ARTIFICIAL INTELLIGENCE SYSTEM WITH BIDIRECTIONAL ANONYMIZATION AND EXPERT RECONCILIATION FOR DOCUMENT ANALYSIS

(71) Applicant: EXPERITAS INC., Portland, OR (US)

(72) Inventor: Andy Stuart Barnett, Portland, OR (US)

(21) Appl. No.: 19/535,130

(22) Filed: Feb. 10, 2026

Related U.S. Application Data
(60) Provisional application No. 63/777,574, filed on Mar. 25, 2025.

(51) Int. Cl. G06Q 10/06; G06Q 10/10

(52) U.S. Cl. CPC G06Q 10/06; G06Q 10/10

(57) ABSTRACT

A multi-stage AI-based document processing system. The system can receive documents in multiple formats, extract text content using optical character recognition when necessary, and identify sensitive data for anonymization. The system can implement bidirectional anonymization wherein sensitive information is replaced with pseudonymized representations using cryptographic mapping structures enabling subsequent restoration. An artificial intelligence module configured with domain-specific prompts can analyze anonymized documents to generate preliminary structured reports including chronological timelines, assessments, and literature references. Literature citations can be verified against external databases to prevent fabricated references. Anonymized preliminary reports can be transmitted to external domain experts through secure interfaces for validation and feedback. A reconciliation module can synthesize preliminary reports, expert feedback, and source documents using conflict resolution algorithms and source hierarchy rules. Patient identification can be restored using the cryptographic mappings, and final reports can be generated in distribution formats incorporating expert-validated content with verified factual accuracy.

### CROSS-REFERENCE TO RELATED APPLICATION

This patent application claims the benefit of, and priority to, U.S. Provisional Application No. 63/777,574, filed Mar. 25, 2025, the content of which is hereby incorporated by reference in its entirety.

### BACKGROUND

Expert discovery procedures in legal disputes are complex, time consuming, manually intensive, and prone to human error, resulting in judicial and cost inefficiencies and unjust outcomes.

### SUMMARY

Embodiments of the present disclosure are directed to improvements in large language model performance in specific technical contexts, such as a legal dispute context.

In one aspect, a method for improving performance of a large language model can include training the large language model to generate medical case summaries and medical expert reports and to identify information relevant to generation of the medical case summaries missing from text files, thereby providing a trained large language model. The method can include receiving medical files having a plurality of file formats and executing, using at least one processor, a script stored on non-transitory computer-readable storage. The executing can include extracting text from the medical files to generate extracted text, wherein for one of the files the method can include determining that a page includes fewer than a predefined threshold number of readable characters and, based thereon, performing optical character recognition on the page. The method can include identifying sensitive data in the extracted text, anonymizing the sensitive data to anonymize the extracted text and provide extracted anonymized text, and combining contents of the medical files into a single text file using the extracted anonymized text. The method can include providing the text file to the trained large language model together with a first prompt, determining using the trained large language model information missing from the text file, and generating using the trained large language model a request on a first user interface requesting submission of the information missing from the text file. The method can include receiving by the trained large language model via the first user interface a response to the request, generating by the large language model based on the response and using the text file and the first prompt an anonymized case summary, receiving by the trained large language model via a second user interface a textual comment about the anonymized case summary, and generating a report by the trained large language model using the anonymized case summary, the textual comment, the medical files, and a second prompt, wherein the report can include the sensitive data.

In another aspect, a system for improving performance of a large language model can include a server device, a first display device, at least one processor, and non-transitory computer-readable storage having stored thereon instructions which, when executed by the at least one processor, cause the system to perform the methods described herein, including training the large language model, receiving medical files at the server device, extracting text with adaptive optical character recognition, identifying and anonymizing sensitive data, providing text files to the trained large language model with prompts, determining missing information, generating requests on user interfaces, receiving responses and textual comments, and generating reports including the sensitive data.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a system for automated document processing with privacy-preserving transformations, artificial intelligence-based analysis, expert validation, and multi-source reconciliation.

FIG. 2 shows an example functional architecture of a server device of the system of FIG. 1.

FIG. 3 shows an example method for performing automated document analysis with anonymization, artificial intelligence-based preliminary report generation, expert review, and reconciliation using the system of FIG. 1.

FIG. 4 shows an example graphical user interface for case portal management and document upload functionality accessible via a client device of the system of FIG. 1.

FIG. 5 shows an example method for configuring a case manager prompt and generating preliminary reports, corresponding to portions of the method of FIG. 3.

FIG. 6 shows an example method for configuring a reconciliation prompt and generating final reports by synthesizing expert feedback with source documents, corresponding to portions of the method of FIG. 3.

FIG. 7 shows example physical hardware components of the server device of FIG. 2.

### DETAILED DESCRIPTION

This disclosure relates to automated document processing systems and, more particularly, to multi-stage document analysis systems with reversible data anonymization, artificial intelligence-based content generation, and automated fact verification capabilities.

Document processing systems can encounter substantial technical challenges when handling documents containing protected or sensitive information that must undergo multi-stage analysis workflows involving external reviewers. Conventional systems may face limitations in implementing privacy-preserving transformations that maintain both data protection and contextual information utility during processing operations. Text extraction from mixed-format documents including native digital content and variable-quality scanned images can present accuracy challenges requiring adaptive processing techniques. Artificial intelligence models configured to generate analytical content based on document inputs may produce outputs containing fabricated references or unsupported factual assertions, which can be particularly problematic in domains requiring high factual accuracy. Systems that must synthesize multiple data sources, such as automated preliminary analyses, external expert feedback, and original source documents, into unified outputs may require computationally intensive manual reconciliation processes when conflicts arise between sources. Additionally, workflows requiring reversible anonymization, wherein documents are de-identified for external review and subsequently re-identified for final outputs, may lack efficient mechanisms for maintaining cryptographic linkage between original and pseudonymized data elements. These challenges can constrain the scalability, accuracy, and reliability of automated document processing systems in contexts where privacy compliance, expert validation, and factual precision are important operational considerations.

Automated analysis of complex documents, particularly those containing protected or sensitive information, can present substantial technical challenges in various domains. In many workflows involving multi-party review of confidential documents, systems may be configured to extract textual content from mixed-format files, apply transformations to protect sensitive information, generate preliminary analyses, and synthesize feedback from domain experts into final outputs. Conventional document processing systems can face challenges when handling documents that combine digitally-created content with scanned images, handwritten annotations, and variable-quality reproductions. Text extraction accuracy may be constrained by image quality variations, skewed pages, or inconsistent formatting across document sources.

Systems that process documents containing personally identifiable information or protected data can encounter limitations related to privacy preservation during multi-stage workflows. Conventional anonymization approaches may over-redact content, thereby losing contextual information useful for downstream analysis, or may under-redact content, creating compliance risks. In workflows where anonymized documents are transmitted to external reviewers and subsequently de-anonymized for final output, conventional systems may lack efficient mechanisms for maintaining cryptographic linkage between original and pseudonymized data elements, potentially introducing data integrity risks or requiring computationally expensive reconciliation operations. Additionally, artificial intelligence models configured to generate content based on document analysis may produce outputs containing fabricated references, non-existent citations, or factual assertions unsupported by source materials, a phenomenon that can be particularly problematic in domains requiring high factual accuracy.

When multiple data sources, such as preliminary automated analyses, expert feedback, and original source documents, must be synthesized into a unified output, conventional systems may require manual reconciliation processes that can be time-intensive and error-prone. The challenges of identifying conflicts between multiple input sources, applying hierarchical prioritization rules, and verifying factual accuracy against source materials can result in processing delays, increased computational overhead, and reduced output reliability. These limitations can constrain the scalability and practical deployment of automated document analysis systems in contexts where accuracy, privacy compliance, and processing efficiency are important considerations.

The present disclosure can address technical challenges in processing documents containing sensitive information through multi-stage workflows that maintain data protection during external review while enabling restoration of identification in final outputs. The systems and methods can implement adaptive text extraction techniques that selectively apply optical character recognition based on digital text availability, bidirectional anonymization using cryptographic mapping structures, artificial intelligence models configured with domain-specific prompts for generating preliminary analyses, mechanisms for identifying and requesting missing information, secure interfaces for capturing external expert feedback, and reconciliation algorithms for synthesizing multiple input sources into unified outputs with verified factual accuracy.

The challenges described above can be addressed through a multi-stage computing architecture configured to process documents with enhanced privacy preservation, automated content generation with verification mechanisms, and intelligent synthesis of multi-source inputs. The technology can include a distributed computing environment including client devices, server devices, data storage systems, and external resource interfaces communicatively coupled via one or more networks. In some embodiments, the server device can include a plurality of functional modules configured to execute distinct phases of document processing, analysis, and report generation. The computing environment can be configured to maintain secure data transmission pathways between components while implementing encryption protocols for data at rest and in transit.

The technology can be configured to receive documents in multiple formats, including portable document format (PDF) files, word processing documents, and image files containing scanned or photographed content. Upon receiving documents at a server device, the technology can initiate a document processing phase wherein textual content is extracted from native digital formats and, where necessary, optical character recognition (OCR) processing is applied to image-based content. In some implementations, the technology can assess image quality characteristics and selectively apply preprocessing transformations to enhance OCR accuracy for low-quality scanned documents. The extracted textual content can be aggregated and prepared for subsequent processing stages.

The technology can implement a bidirectional anonymization architecture configured to identify protected information within documents and apply reversible pseudonymization transformations. In some embodiments, a first module can be configured to detect personally identifiable information using pattern recognition techniques, named entity recognition models, or combinations thereof. A second module can be configured to replace identified information elements with pseudonymized representations while maintaining a cryptographic mapping structure that enables subsequent restoration of original information. The cryptographic mapping can be stored in a secure data store with hash-based indexing to enable efficient retrieval operations. This approach can facilitate privacy-preserving analysis workflows where anonymized content is transmitted to external parties, while preserving the capability to restore original information in final outputs delivered to authorized recipients.

The technology can incorporate artificial intelligence-based analysis capabilities configured to generate preliminary structured outputs based on anonymized document content. In some embodiments, a large language model or other machine learning architecture can be configured with domain-specific instructions that define an analytical role, output formatting requirements, and operational constraints. The model can analyze anonymized textual content to identify relevant information elements, construct chronological event sequences, assess content according to predefined criteria, and generate preliminary reports in structured formats. The technology can implement hallucination prevention mechanisms wherein references to external sources generated by the artificial intelligence model are verified against external databases or repositories prior to inclusion in outputs. In some implementations, unverified references can be flagged, annotated with disclaimer text, or removed from generated content depending on the verification stage and output destination.

The technology can facilitate interaction with external domain experts or reviewers through a secure interface portal configured to present anonymized preliminary outputs and capture feedback. In some embodiments, the interface portal can implement authentication mechanisms, session management protocols, and data transmission security measures to protect anonymized content during external review. Expert reviewers can access preliminary reports via the portal, provide validations or corrections of content, offer professional opinions or assessments, and submit feedback that is captured and stored in the data store. The technology can be configured to maintain expert anonymity in final outputs by referring to reviewers through generic identifiers rather than personal names.

The technology can implement a reconciliation architecture configured to synthesize multiple input sources into unified final outputs. In some implementations, a reconciliation module can receive a preliminary report generated by artificial intelligence analysis, expert feedback captured through the interface portal, and original source documents, and can execute algorithms to identify discrepancies between these sources. The technology can apply hierarchical source prioritization rules wherein expert feedback is treated as authoritative for resolving conflicts with artificial intelligence-generated content, while factual assertions are verified against original source documents. In some embodiments, the reconciliation module can implement three-way merge algorithms, semantic similarity computations, or evidence scoring techniques to automate conflict resolution. The technology can be configured to flag irreconcilable conflicts for manual review when automated resolution is not feasible.

The technology can incorporate a continuous improvement capability wherein expert feedback is analyzed to identify systematic discrepancies between artificial intelligence outputs and expert validations. In some embodiments, correction pairs including original inputs, incorrect artificial intelligence outputs, and expert-validated correct outputs can be extracted and added to training datasets for iterative model refinement. The technology can implement privacy-preserving techniques such as differential privacy noise injection to enable aggregate learning from correction data while protecting individual case confidentiality. Iterative model updates can be deployed through controlled testing frameworks that evaluate performance metrics before full production deployment, enabling measurable improvements in output accuracy over time.

Through these integrated capabilities, the technology can provide enhanced document processing workflows characterized by improved privacy preservation through reversible anonymization, reduced factual inaccuracies through multi-stage verification, efficient synthesis of multi-source inputs through automated reconciliation, and progressive performance improvements through feedback-driven learning mechanisms. The architecture can enable scalable deployment across diverse use cases where automated analysis of sensitive documents with expert validation is beneficial.

The technology employs a novel multi-stage processing architecture that integrates adaptive optical character recognition with quality-based preprocessing, bidirectional anonymization using cryptographic hash-indexed mapping structures, multi-stage citation verification against external databases, and automated three-way merge algorithms for conflict resolution into a cohesive framework that improves computer functionality when processing sensitive documents through privacy-preserving analysis workflows. Through specialized processing of mixed-format document inputs, the technology overcomes technical challenges associated with maintaining both privacy protection and contextual information preservation during anonymization operations. The bidirectional anonymization architecture can achieve deterministic identity restoration with hash table lookups, reducing computational overhead while maintaining data integrity through checksum verification mechanisms.

Large language models in conventional implementations can exhibit technical deficiencies when generating domain-specific analytical content, including hallucination artifacts wherein models fabricate literature citations, medical procedures, or factual assertions not present in source documents, lack of grounding mechanisms to verify generated content against authoritative external databases, inability to detect and reconcile conflicting information between AI-generated preliminary analyses and expert-provided feedback, and static model architectures that cannot incorporate domain expert corrections to improve future inference operations. The technology described herein addresses these deficiencies through a dual-prompt architecture that separates preliminary analysis generation from expert-feedback reconciliation operations, implementing citation verification modules that query external medical literature databases via API connections to validate existence and accuracy of generated references before report finalization, deploying three-way merge algorithms that systematically compare AI-generated content against both source document text and expert-provided corrections to resolve conflicts using hierarchical source prioritization rules, and implementing feedback loop mechanisms that extract correction patterns from expert modifications to generate training data pairs for continuous model improvement. These technical solutions transform conventional single-stage LLM inference into a multi-stage verification and reconciliation pipeline that reduces hallucination rates, improves factual accuracy through external database validation, and enables iterative model enhancement through structured capture of domain expert corrections, thereby improving the reliability and trustworthiness of AI-generated outputs in high-stakes domains requiring factual precision such as medical-legal case analysis.

The technology employs a novel multi-stage processing architecture that integrates adaptive optical character recognition with quality-based preprocessing, bidirectional anonymization using cryptographic hash-indexed mapping structures, multi-stage citation verification against external databases, and automated three-way merge algorithms for conflict resolution into a cohesive framework that improves computer functionality when processing sensitive documents through privacy-preserving analysis workflows. Through specialized processing of mixed-format document inputs, the technology overcomes technical challenges associated with maintaining both privacy protection and contextual information preservation during anonymization operations. The bidirectional anonymization architecture can achieve deterministic identity restoration with hash table lookups, reducing computational overhead while maintaining data integrity through checksum verification mechanisms.

The technology can utilize machine learning models configured with domain-adapted parameters and iterative verification algorithms that generate structured outputs from document datasets, achieving adaptive refinement through expert feedback integration and improved factual accuracy through multi-stage hallucination prevention protocols compared to static baseline models. In some embodiments, the architecture can implement a dual-prompt configuration wherein a first large language model instance executes preliminary analysis on anonymized data with reduced privacy-tracking computational overhead, while a second model instance executes final synthesis incorporating expert feedback with reduced error-checking cycles due to expert validation, thereby achieving computational efficiency improvements relative to single-pass architectures. The technology can incorporate continuous learning mechanisms that extract correction pairs from expert feedback, apply differential privacy transformations, and execute controlled model updates with performance validation gates, enabling measurable accuracy improvements over operational lifecycles.

The architecture can include a reconciliation module that coordinates technical operations across distributed data sources including preliminary artificial intelligence outputs, external expert feedback captured through secure portal interfaces, and original source documents stored in persistent data repositories, solving technical challenges of conflict detection, hierarchical source prioritization, and evidence-based fact verification in automated workflows. The technology can implement semantic similarity computations using sentence embedding models with cosine distance metrics to distinguish substantive conflicts from stylistic variations, directed acyclic graph representations of factual assertions with topological sorting for dependency-ordered processing, and evidence scoring algorithms using ranking functions to automate conflict resolution without manual intervention. In some implementations, optimizations such as verified citation caching with time-to-live expiration, batch database operations with buffered writes, and parallel inference processing across multiple model instances can reduce computational overhead and improve response times for complex document analysis operations involving thousands of pages and multiple specialty domains.

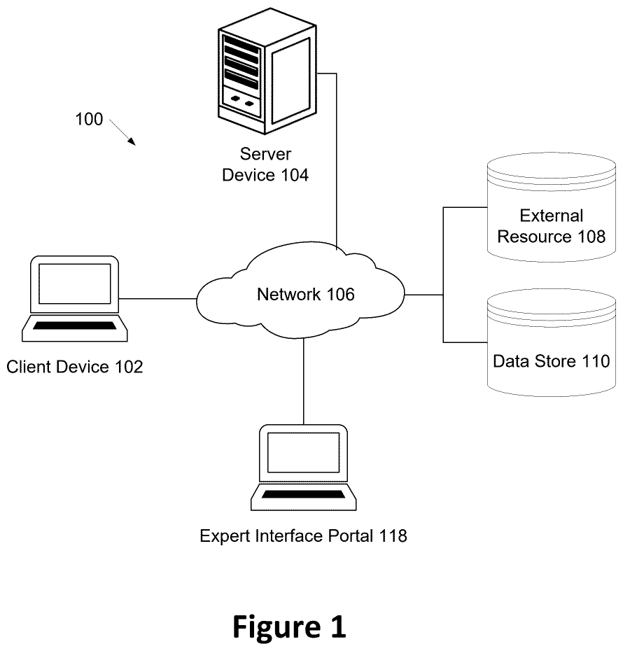

FIG. 1 illustrates a schematic diagram of system 100, which can be configured to perform automated document processing with privacy-preserving transformations, artificial intelligence-based analysis, expert validation, and multi-source reconciliation. System 100 can include one or more client devices 102, one or more server devices 104, one or more data stores 110, one or more expert interface portals 118, and one or more external resources 108, which can be communicatively coupled via one or more networks 106. In some embodiments, system 100 can be configured to process documents containing protected information, apply reversible anonymization transformations, generate preliminary structured outputs using artificial intelligence models, facilitate expert review through secure interfaces, and synthesize final outputs incorporating expert feedback with automated fact verification.

Client device 102 can include a computing device configured to communicate with server device 104 via network 106. In some embodiments, client device 102 can include one or more processors, memory components, input/output interfaces, and network communication interfaces. Client device 102 may include, for example, a desktop computer, laptop computer, tablet device, smartphone, workstation, or other computing apparatus capable of executing applications and transmitting data over network connections. In some implementations, client device 102 can be configured to execute a web browser, native application, or other client software that provides a user interface for interacting with system 100. Client device 102 can be configured to transmit documents to server device 104, receive processing status notifications, access case management interfaces, and retrieve final outputs generated by system 100. In some embodiments, multiple client devices 102 may be deployed across different users or organizations, each communicating with server device 104 through authenticated and encrypted connections.

Users of client device 102 can include attorneys in plaintiff or defense medical malpractice firms who upload medical records and request case evaluations, institutional risk managers at healthcare facilities who assess potential liability exposure, health systems that evaluate adverse events for internal quality review or litigation preparedness, payors or malpractice insurance carriers that review claims to determine coverage or settlement positions, and state medical boards that evaluate physician complaints or disciplinary matters. In some implementations, high-volume medical malpractice law firms may deploy client device 102 across multiple staff members including paralegals, case managers, or associate attorneys who manage document uploads and preliminary case screening, while partners or senior attorneys retrieve and review final expert-validated reports for use in settlement negotiations, motion practice, or trial preparation.

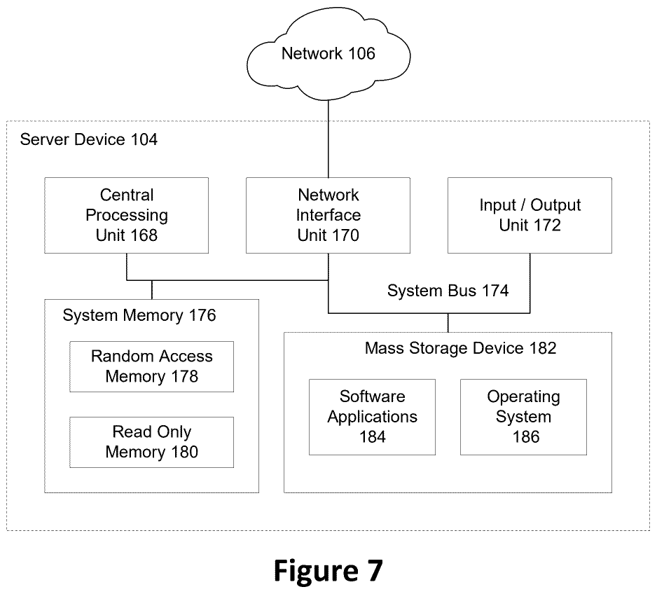

Server device 104 can include one or more computing servers configured to execute the primary processing operations of system 100. In some embodiments, server device 104 may be implemented as a single physical server, a distributed server architecture including multiple server instances, a cloud-based computing environment with elastic resource allocation, or a hybrid architecture combining on-premises and cloud-hosted components. Server device 104 can include one or more processors, system memory including volatile and non-volatile storage, mass storage devices, network interfaces, and other hardware components described in further detail with reference to FIG. 7.

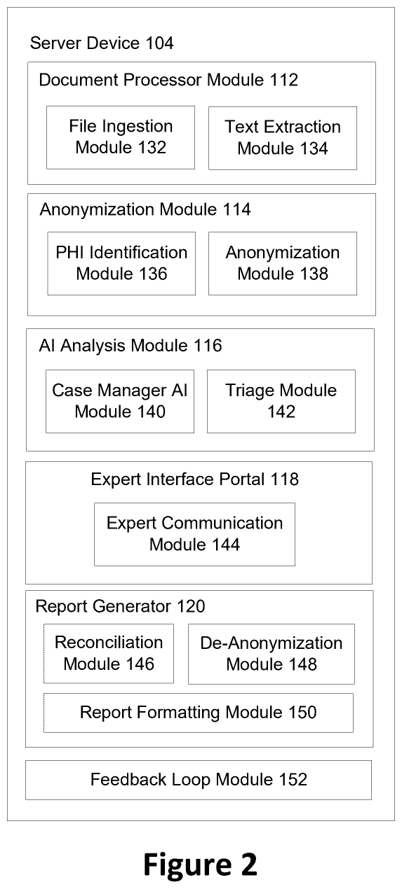

In some implementations, server device 104 can execute a plurality of software engines configured to perform document processing, text extraction, anonymization, artificial intelligence-based analysis, reconciliation, and report generation operations. These engines, which are described in detail with reference to FIG. 2, can include a document processor engine, an anonymization engine, an artificial intelligence analysis engine, and a report generator engine, among others. Server device 104 can be configured to access data store 110 for persistent storage and retrieval of documents, processed content, cryptographic mapping structures, expert feedback, and other data elements utilized throughout processing workflows.

In some embodiments, computing resources utilized by system 100 may be distributed between client device 102 and server device 104 according to various architectural configurations. For example, in a thin-client architecture, server device 104 may perform substantially all computational processing while client device 102 provides primarily user interface and data transmission capabilities. Alternatively, in a computing architecture where the client device (e.g., the user's computer or workstation) performs substantial processing operations locally, rather than relying entirely on the server to do the work, certain preprocessing operations such as document validation, format conversion, or initial text extraction may be performed on client device 102 prior to transmission to server device 104, thereby reducing network bandwidth consumption and server computational load. In some implementations, client device 102 and server device 104 may dynamically allocate processing tasks based on available computational resources, network latency characteristics, or data security considerations.

External resource 108 can include one or more third-party systems, databases, application programming interfaces (APIs), or computing services that provide supplemental data or computational capabilities to system 100. In some embodiments, external resource 108 may include medical literature databases such as PubMed or MEDLINE, which can be queried to verify citations or retrieve article metadata. External resource 108 may also include scholarly publication repositories providing digital object identifier (DOI) resolution services, journal impact factor databases, retraction databases, or other reference verification resources. In some implementations, external resource 108 can include domain-specific knowledge bases, clinical guidelines repositories, medical terminology ontologies such as SNOMED CT or LOINC, or pharmaceutical databases such as RxNorm. Server device 104 can communicate with external resource 108 via network 106 using standardized protocols such as REST APIs, SOAP web services, or FHIR (Fast Healthcare Interoperability Resources) interfaces. In some embodiments, external resource 108 may be operated by independent third-party organizations, governmental entities, academic institutions, or contracted service providers, and may require authentication credentials, API keys, or subscription access for querying.

Data store 110 can include one or more persistent storage systems configured to maintain data utilized by system 100 across processing workflows and operational lifecycles. In some embodiments, data store 110 may be implemented using relational database management systems (RDBMS) such as PostgreSQL or MySQL, NoSQL databases such as MongoDB or Cassandra, object storage systems such as Amazon S3 or Azure Blob Storage, or combinations thereof optimized for different data types and access patterns.

Data store 110 can store uploaded documents in original formats, extracted textual content, cryptographic mapping tables linking anonymized and original data elements, preliminary reports generated by artificial intelligence engines, expert feedback captured through expert interface portal 118, final synthesized outputs, and audit logs documenting processing operations. In some implementations, data store 110 can maintain a medical literature database including article metadata, abstracts, and citation information extracted from external resource 108 and cached for improved query performance. Data store 110 can also store artificial intelligence model parameters, training datasets, correction pairs extracted from expert feedback, and performance metrics used for continuous model improvement. In some embodiments, data store 110 can implement encryption at rest, access control mechanisms, backup and replication protocols, and retention policies configured to comply with data protection regulations.

Expert interface portal 118 can include a secure web-based application or platform configured to facilitate interaction between system 100 and external domain experts or reviewers. In some embodiments, expert interface portal 118 may be implemented as a web application executing on server device 104 or on separate server infrastructure, accessible through web browsers on expert computing devices via network 106. Expert interface portal 118 can implement authentication mechanisms such as username/password credentials, multi-factor authentication, single sign-on (SSO) protocols, or federated identity systems to verify expert identities. In some implementations, expert interface portal 118 can present anonymized preliminary reports generated by system 100, provide user interface elements for experts to submit feedback, validations, corrections, or professional opinions, and capture submitted feedback for storage in data store 110.

Experts accessing expert interface portal 118 can include board-certified physicians and medical specialists across various disciplines such as emergency medicine, cardiology, obstetrics and gynecology, anesthesiology, radiology, surgery, neurology, oncology, or other medical specialties relevant to the case content being analyzed. In some embodiments, experts may be identified and recruited through full-service expert witness sourcing firms such as Expert Institute (EIQ), which provides vetting, credential verification, conflicts checking, and logistics management to identify qualified physicians who meet jurisdiction-specific requirements and are willing to provide case reviews, affidavits of merit, and testimony. Alternatively, experts may be sourced through directory platforms such as SEAK, Inc., which maintains searchable databases of physicians and medical professionals interested in expert witness work, many of whom have received training through educational seminars on providing medical-legal opinions. In some implementations, experts providing feedback through expert interface portal 118 may be evaluated for credibility and prior testimony history using intelligence databases such as those provided by ALM (including VerdictSearch and jury verdict analysis platforms), which enable due diligence regarding an experts litigation experience, case outcomes, and potential impeachment issues, thereby ensuring that experts selected for case review possess appropriate qualifications and credibility for subsequent legal proceedings.

Expert interface portal 118 can be configured to maintain expert anonymity in system outputs by using generic identifiers such as Board-Certified Expert in [Specialty]” rather than personal names when incorporating expert input into final reports delivered to client device 102. In some embodiments, expert interface portal 118 can implement session management, data transmission encryption, audit logging, and other security measures to protect anonymized content during external review processes while documenting expert contributions for quality assurance and continuous improvement of artificial intelligence models as described with reference to feedback loop operations in method 200.

Network 106 can include one or more communication networks configured to enable data transmission between components of system 100. In some embodiments, network 106 may include the Internet, private networks, virtual private networks (VPNs), local area networks (LANs), wide area networks (WANs), cellular networks, or combinations thereof. Network 106 can support various communication protocols including Transmission Control Protocol/Internet Protocol (TCP/IP), Hypertext Transfer Protocol Secure (HTTPS), Transport Layer Security (TLS), or other protocols that enable secure, reliable data exchange. In some implementations, communications over network 106 can be encrypted using cryptographic protocols to protect data confidentiality during transmission between client device 102 and server device 104, between server device 104 and external resource 108, and between server device 104 and expert interface portal 118. Network 106 can support both synchronous and asynchronous communication patterns, enabling real-time or near-real-time data transmission for interactive operations as well as batch data transfers for large document uploads or report deliveries. In some embodiments, network 106 can implement load balancing, failover mechanisms, quality of service (QoS) policies, or content delivery network (CDN) capabilities to optimize performance and reliability of data transmission across geographically distributed system components.

FIG. 2 illustrates a functional architecture of server device 104, which was introduced with reference to FIG. 1. Server device 104 can include a plurality of software-based functional modules configured to execute distinct processing operations within the multi-stage document analysis workflow. In some embodiments, these modules may be implemented as discrete software components, microservices, containerized applications, or integrated subsystems executing on the hardware infrastructure of server device 104. Each module can be configured to perform specialized functions and can communicate with other modules through internal application programming interfaces (APIs), message queues, shared memory structures, or other inter-process communication mechanisms. The modular architecture can provide flexibility for scaling individual components, updating software versions independently, and deploying system 100 across distributed computing environments.

Server device 104 can include document processor module 112, which can be configured to handle initial intake and processing of documents received from client device 102. In some embodiments, document processor module 112 can include file ingestion module 132 and text extraction module 134.

File ingestion module 132 can be configured to receive document uploads transmitted from client device 102 via network 106, validate file formats and sizes, perform malware scanning or security checks, and store received files in data store 110. In some implementations, file ingestion module 132 may apply file type validation to ensure that uploaded documents conform to supported formats such as portable document format (PDF), Microsoft Word document format (DOCX), Joint Photographic Experts Group (JPEG) image format, Portable Network Graphics (PNG) format, or Tagged Image File Format (TIFF). Text extraction module 134 can be configured to extract textual content from received documents using format-specific parsing techniques. For documents containing native digital text, text extraction module 134 may extract character data directly from file structures. For documents including scanned images or image-based PDF pages, text extraction module 134 can implement optical character recognition (OCR) processing using engines such as Tesseract, ABBYY FineReader, or cloud-based OCR services. In some embodiments, text extraction module 134 may perform image quality assessment to determine whether preprocessing operations such as de-skewing, noise reduction, contrast enhancement, or binarization should be applied prior to OCR processing, thereby improving character recognition accuracy for low-quality scanned documents.

Server device 104 can include anonymization module 114, which can be configured to identify and transform protected health information (PHI) or other sensitive data elements within processed documents. In some embodiments, anonymization module 114 can include PHI identification module 136 and pseudonymization module 138. PHI identification module 136 can be configured to detect personally identifiable information using pattern recognition techniques, regular expression matching, named entity recognition models, or combinations thereof. In some implementations, PHI identification module 136 may apply regex patterns configured to detect common PHI formats including email addresses conforming to RFC 5322 standards, Social Security Numbers in XXX-XX-XXXX format and variants, telephone numbers conforming to North American Numbering Plan formats, dates in various medical documentation formats, physical addresses, and medical record numbers. PHI identification module 136 may also implement machine learning-based named entity recognition using models such as bidirectional long short-term memory with conditional random fields (BiLSTM-CRF), transformer-based architectures such as BERT or BioBERT, or domain-adapted models trained on clinical text datasets. In some embodiments, PHI identification module 136 may perform contextual disambiguation to distinguish between ambiguous entities, such as differentiating physician names from patient names based on surrounding context. Pseudonymization module 138 can be configured to replace identified PHI elements with pseudonymized representations while maintaining a cryptographic mapping structure that enables subsequent restoration of original information. In some implementations, pseudonymization module 138 may replace patient full names with initials, shift dates of birth by random offsets within a defined range, replace other personal names with generic descriptors such as “Physician” or “Relative,” and replace contact information with synthetic but format-conforming data. Pseudonymization module 138 can generate and store cryptographic mapping tables in data store 110, wherein each original PHI element is associated with a universally unique identifier (UUID) or hash-based key, enabling efficient retrieval during de-anonymization operations.

Server device 104 can include artificial intelligence (AI) analysis module 116, which can be configured to generate preliminary structured outputs based on anonymized document content. In some embodiments, AI analysis module 116 can include case manager AI module 140 and triage module 142. Case manager AI module 140 can implement a large language model (LLM) or other machine learning architecture configured with domain-specific instructions that define an analytical role, output formatting requirements, and operational constraints. In some implementations, case manager AI module 140 may be based on transformer architectures with billions of parameters, fine-tuned on domain-specific corpora including medical literature, clinical guidelines, case precedents, or expert witness reports. The module can be configured to analyze anonymized textual content, identify relevant information elements, construct chronological event sequences, assess content according to predefined criteria, and generate preliminary reports in structured formats such as Hypertext Markup Language (HTML).

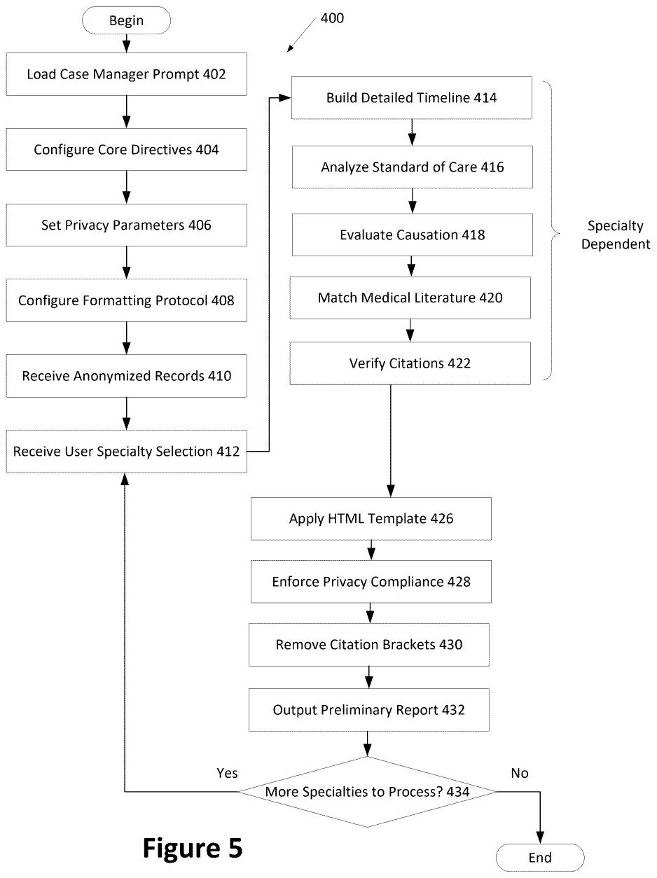

In some embodiments, case manager AI module 140 may implement the prompt configuration and report generation procedures described with reference to method 400 in FIG. 5. Triage module 142 can be configured to perform classification operations on case content to identify required domain expertise, assign merit scores or priority levels, and detect potential issues warranting further analysis. In some implementations, triage module 142 may implement multi-label classification models using hierarchical transformer architectures, focal loss optimization to address class imbalance, or confidence calibration techniques such as temperature scaling to improve probability reliability. Triage module 142 can generate case intake summaries identifying relevant specialty domains, potential areas of concern organized by specialty, and recommendations for expert reviewer selection.

Expert interface portal 118, which was introduced with reference to FIG. 1, can include server-side components integrated within server device 104. In some embodiments, expert interface portal 118 can include expert communication module 144, which can be configured to facilitate transmission of anonymized preliminary reports to external domain experts and capture feedback submitted through the portal interface. Expert communication module 144 can implement authentication mechanisms such as username/password credentials with cryptographic hashing, multi-factor authentication using time-based one-time passwords (TOTP), single sign-on (SSO) protocols such as Security Assertion Markup Language (SAML) or OpenID Connect, or federated identity systems. In some implementations, expert communication module 144 may implement session management using JSON Web Tokens (JWT) with configurable expiration windows, stateless authentication to reduce server memory requirements, or distributed session storage using Redis or similar in-memory data stores.

Expert communication module 144 can present anonymized reports through web-based user interfaces, capture structured feedback through forms or interactive elements, store submitted feedback in data store 110 with timestamps and expert identifiers, and generate notifications to client device 102 when expert review is completed. In some embodiments, expert communication module 144 may implement real-time collaboration features such as conflict-free replicated data types (CRDTs) enabling multiple experts to simultaneously annotate different sections of reports, differential synchronization protocols that transmit only character-level changes to reduce bandwidth consumption, or version control mechanisms that maintain histories of expert edits.

Server device 104 can include report generator module 120, which can be configured to synthesize final outputs incorporating multiple input sources. In some embodiments, report generator module 120 can include reconciliation module 146, de-anonymization module 148, and report formatting module 150. Reconciliation module 146 can be configured to receive preliminary reports generated by AI analysis module 116, expert feedback captured through expert interface portal 118, and original source documents from data store 110, and to execute algorithms for identifying and resolving discrepancies between these sources. In some implementations, reconciliation module 146 may implement three-way merge algorithms, semantic similarity computations using sentence embedding models, evidence scoring techniques using ranking functions, or hierarchical source prioritization rules wherein expert feedback is treated as authoritative for conflict resolution.

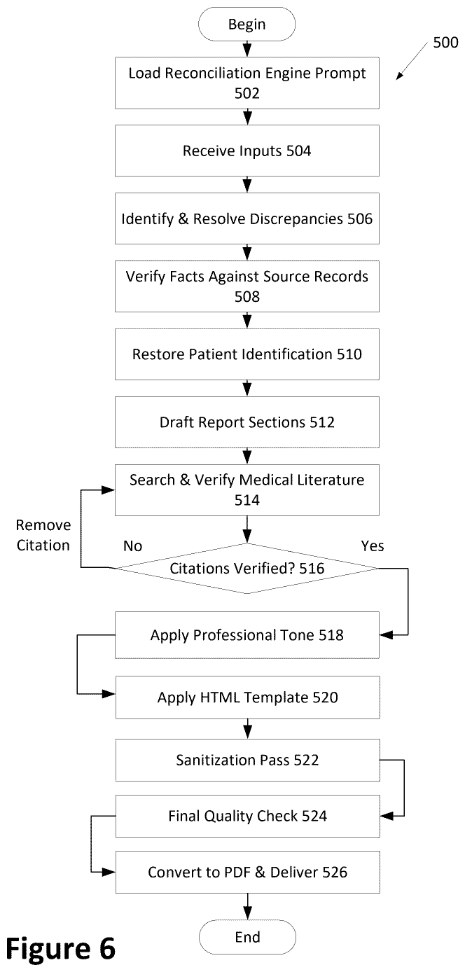

Reconciliation module 146 may construct directed acyclic graph (DAG) representations of factual assertions, perform topological sorting to process dependencies in logical order, and apply conflict resolution logic based on configurable source hierarchies. In some embodiments, reconciliation module 146 may implement the prompt configuration and reconciliation procedures described with reference to method 500 in FIG. 6. De-anonymization module 148 can be configured to restore original identification information in final outputs by retrieving cryptographic mappings from data store 110 and replacing pseudonymized elements with corresponding original PHI elements. In some implementations, de-anonymization module 148 may perform hash table lookups with O(1) computational complexity, apply checksum verification to ensure data integrity during restoration, and generate audit logs documenting de-anonymization operations for compliance purposes. Report formatting module 150 can be configured to apply structured templates to synthesized content and convert formatted outputs to distribution formats. In some embodiments, report formatting module 150 may apply HTML and Cascading Style Sheets (CSS) templates defining typography, spacing, table formatting, and layout specifications, then convert HTML documents to portable document format (PDF) using rendering engines such as WeasyPrint, wkhtmltopdf, or cloud-based conversion services.

Server device 104 can include feedback loop module 152, which can be configured to implement continuous improvement capabilities through analysis of expert feedback. In some embodiments, feedback loop module 152 can extract correction pairs from reconciliation logs stored in data store 110, wherein each correction pair includes an original input, an AI-generated output that was determined to be incorrect or suboptimal, and an expert-validated correct output. Feedback loop module 152 can apply privacy-preserving transformations such as differential privacy noise injection to correction data prior to incorporation into training datasets, ensuring that individual case information cannot be reconstructed from aggregate training data. In some implementations, feedback loop module 152 may implement active learning heuristics to prioritize high-value corrections for model retraining, such as uncertainty sampling that prioritizes corrections where the AI model exhibited high confidence but was contradicted by expert feedback, diversity sampling using clustering techniques to ensure correction pairs cover diverse scenarios, or difficulty scoring that prioritizes complex multi-step reasoning corrections.

Feedback loop module 152 can perform incremental fine-tuning operations on AI models using techniques such as low-rank adaptation (LoRA), adapter layers, or experience replay that incorporates both new correction data and samples from original training distributions to prevent catastrophic forgetting. In some embodiments, feedback loop module 152 may implement controlled deployment procedures such as A/B testing, canary deployments with gradual traffic ramping, or shadow mode evaluation wherein updated models process live cases in parallel with production models for performance comparison prior to full deployment.

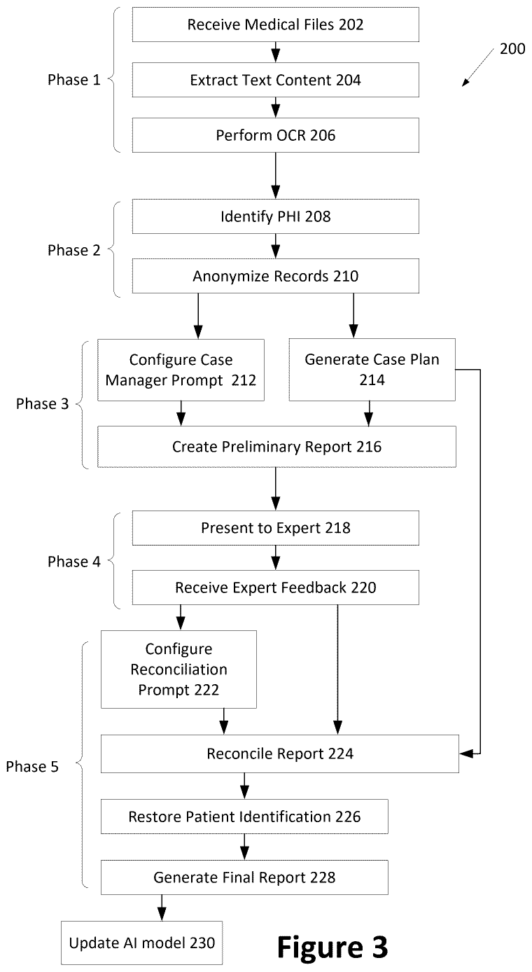

FIG. 3 illustrates a flowchart of method 200, which can be executed by system 100 to perform automated document processing with privacy-preserving transformations, artificial intelligence-based preliminary analysis, expert validation, and multi-source reconciliation. Method 200 can be implemented through execution of software modules within server device 104, as described with reference to FIG. 2, in cooperation with client device 102, expert interface portal 118, data store 110, and external resource 108 communicatively coupled via network 106. In some embodiments, method 200 may be initiated in response to a user action at client device 102, such as uploading documents through a web-based interface or invoking a processing request through an application programming interface (API). The steps of method 200 are described below in a logical sequence, though in some implementations certain steps may be performed in parallel, in alternative orders, or iteratively depending on system configuration and processing requirements.

Method 200 can begin with a document processing phase including steps 202 through 206, which can be executed by document processor module 112. At step 202, server device 104 can receive medical files or other documents uploaded from client device 102. In some embodiments, file ingestion module 132 of document processor module 112 can be configured to accept document transmissions via network 106, which may be formatted as multipart HTTP POST requests, file transfer protocol (FTP) uploads, or other data transmission protocols. The received files may include various formats including portable document format (PDF) files, word processing documents such as Microsoft Word DOCX files, image files in JPEG, PNG, or TIFF formats, or other structured or unstructured document types. In some implementations, step 202 may include validating file integrity through checksum verification, scanning uploaded files for malicious content using antivirus engines, checking file sizes against configurable limits, and verifying that file formats conform to supported types. Upon successful validation, the received files can be stored in data store 110 with associated metadata such as upload timestamps, source identifiers, case identifiers, and file properties.

At step 204, server device 104 can extract text content from the received documents. In some embodiments, text extraction module 134 of document processor module 112 can be configured to parse document structures and extract digital text content using format-specific techniques. For PDF files containing native digital text, text extraction module 134 may utilize libraries such as PyPDF2, pdfminer, or Apache PDFBox to extract character streams from PDF object structures. For word processing documents such as DOCX files, text extraction module 134 may parse XML structures within the document archive to extract textual content and formatting information. In some implementations, text extraction module 134 may analyze each page or document section to determine whether sufficient digital text is present, which may be assessed based on character counts, text-to-image ratios, or detection of embedded fonts. Pages or documents determined to contain insufficient digital text, such as scanned images embedded within PDF files, may be flagged for optical character recognition processing in subsequent steps.

At step 206, server device 104 can perform optical character recognition (OCR) on document pages or images containing insufficient digital text. In some embodiments, text extraction module 134 can apply OCR processing using engines such as Tesseract, cloud-based OCR services, or commercial OCR solutions. Prior to OCR processing, text extraction module 134 may perform image quality assessment to determine whether preprocessing operations should be applied to improve recognition accuracy. In some implementations, image quality assessment may include computing Laplacian variance to measure image blur, analyzing histogram distributions to detect low contrast conditions, performing edge detection to identify skewed pages, or calculating signal-to-noise ratios. For images determined to have quality deficiencies, text extraction module 134 may apply preprocessing transformations such as bilateral filtering to reduce noise while preserving edges, contrast limited adaptive histogram equalization (CLAHE) to enhance local contrast, rotation transformations to correct skew detected through Hough line transforms, or binarization using Otsu's method to optimize threshold selection. Following preprocessing operations when applicable, text extraction module 134 can execute OCR processing to generate character-level text output, which may include confidence scores for recognized characters or words. In some embodiments, text extraction module 134 may implement multi-engine OCR strategies wherein multiple OCR engines process the same image and outputs are combined using confidence-weighted fusion algorithms to improve overall accuracy. The extracted text from step 204 and OCR-processed text from step 206 can be aggregated, formatted, and stored in data store 110 for subsequent processing stages.

Following the document processing phase, method 200 can proceed to an anonymization phase including steps 208 and 210, which can be executed by anonymization module 114. At step 208, server device 104 can identify protected health information (PHI) or other sensitive data elements within the extracted text content. In some embodiments, PHI identification module 136 of anonymization module 114 can be configured to detect personally identifiable information using pattern recognition techniques, machine learning-based named entity recognition, or hybrid approaches. PHI identification module 136 may apply regular expression (regex) patterns configured to match common PHI formats including email addresses conforming to standard formats, Social Security Numbers in various hyphenated and non-hyphenated formats, telephone numbers conforming to North American or international numbering plans, dates in formats commonly used in medical documentation, physical addresses including street names and postal codes, and medical record numbers or other identifiers. In some implementations, PHI identification module 136 may execute machine learning models such as bidirectional long short-term memory with conditional random fields (BiLSTM-CRF), transformer-based models such as BERT or BioBERT, or custom models trained on clinical text datasets to perform named entity recognition (NER) for person names, locations, organizations, and temporal expressions. The machine learning models can generate entity predictions with associated confidence scores and entity type classifications. In some embodiments, PHI identification module 136 may perform contextual disambiguation by analyzing surrounding tokens to distinguish between ambiguous entities, such as differentiating patient names from physician names based on contextual patterns like “Dr.” prefixes or “patient” descriptors. The identified PHI elements can be tagged with entity types, character offsets indicating positions within the text, and confidence scores, which can be stored in structured formats for processing in step 210.

At step 210, server device 104 can anonymize or pseudonymize the identified PHI elements within the documents. In some embodiments, pseudonymization module 138 of anonymization module 114 can be configured to replace identified PHI elements with pseudonymized representations while maintaining a cryptographic mapping structure that enables subsequent restoration of original information. For patient names, pseudonymization module 138 may generate representations using only initials (e.g., “J.D.” for “John Doe”), which may be deterministically derived from the original name or randomly assigned. For dates of birth or other temporal information, pseudonymization module 138 may apply date shifting transformations wherein dates are offset by random values within a defined range, such as plus or minus 14 days, while maintaining consistency across all date references for the same individual to preserve temporal relationships. For other personal names such as physicians or family members, pseudonymization module 138 may replace names with generic descriptors such as “Physician,” “Relative,” or “Healthcare Provider.” For contact information such as phone numbers or addresses, pseudonymization module 138 may generate synthetic but format-conforming replacements or apply redaction. In some implementations, pseudonymization module 138 can generate a cryptographic mapping table wherein each original PHI element is associated with a universally unique identifier (UUID), hash-based key, or encrypted representation. The mapping table can be stored in data store 110 with encryption at rest using symmetric encryption algorithms such as AES-256. In some embodiments, the mapping table may be implemented using hash table data structures with O(1) average-case lookup complexity, enabling efficient retrieval operations during de-anonymization. The anonymized document text, with PHI elements replaced by pseudonymized representations, can be stored in data store 110 as the input for subsequent AI analysis operations.

Method 200 can then proceed to an artificial intelligence analysis phase including steps 212 through 216, which can be executed by AI analysis module 116. At step 212, server device 104 can configure a case manager prompt for artificial intelligence-based analysis of the anonymized documents. In some embodiments, case manager AI module 140 of AI analysis module 116 can be configured to load system instructions that define an analytical role, output formatting requirements, operational constraints, and processing directives for a large language model or other machine learning architecture. The prompt configuration may define the AI's role as a senior case manager or domain expert, specify privacy protocols requiring use of pseudonymized identifiers only, mandate zero-hallucination protocols prohibiting fabrication of citations or facts not present in source documents, define HTML output formatting requirements with specified structure and styling, and establish other operational parameters. In some implementations, the prompt configuration loaded at step 212 may correspond to the detailed prompt structure and configuration procedures described with reference to method 400 in FIG. 5. The configured prompt can establish the behavioral parameters and constraints under which the AI model will operate during subsequent analysis steps.

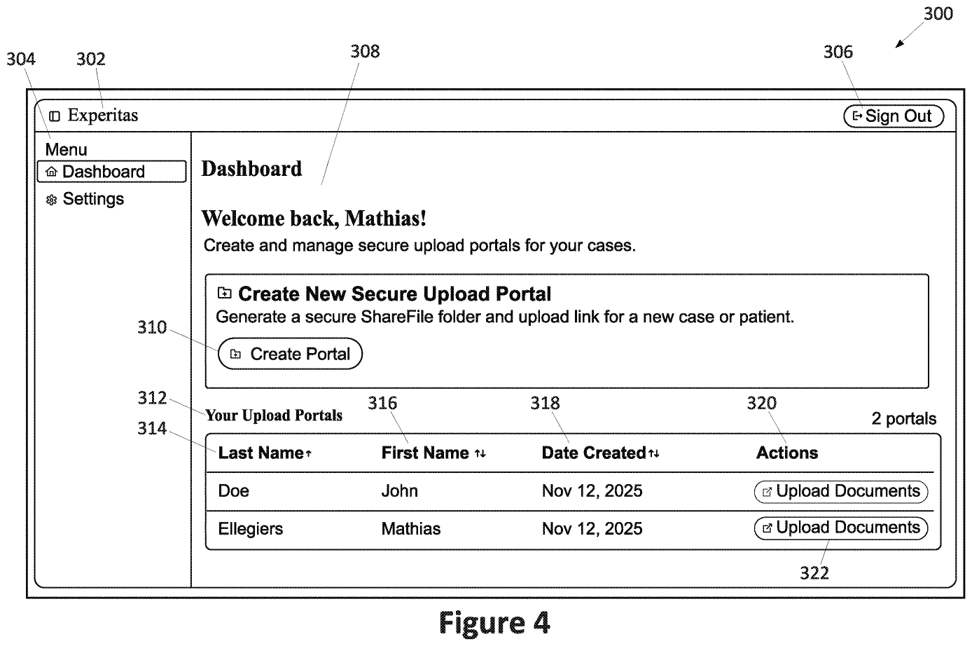

At step 214, server device 104 can generate a case plan based on analysis of the anonymized documents. In some embodiments, case manager AI module 140 and triage module 142 can process the anonymized text extracted and anonymized in previous steps to identify relevant information elements, detect potential issues warranting further analysis, and generate a structured case intake summary. Triage module 142 may perform classification operations to identify which domain specialties are relevant to the case content, which may involve multi-label classification models that assign probability scores to each potential specialty category. In some implementations, triage module 142 may identify specific content elements that suggest potential standard-of-care deviations, procedural errors, diagnostic failures, or other issues of concern, and may organize these identified issues by associated specialty domain. Case manager AI module 140 can generate a case intake summary including patient identifiers in pseudonymized form (e.g., initials and modified date of birth), client organization name, a structured list of potential issues organized by specialty category, and action requests for user selection of which specialty analyses to generate. In some embodiments, the case plan generated at step 214 can be transmitted to client device 102 for presentation through user interface 300, as described with reference to FIG. 4, enabling a user to select which specialty reports should be generated in subsequent processing.

At step 216, server device 104 can create one or more preliminary reports based on the anonymized documents and user selections received in response to the case plan. In some embodiments, case manager AI module 140 can execute the configured case manager prompt to generate structured expert analyses for each selected specialty domain. For each specialty analysis, case manager AI module 140 may construct a chronological event timeline by extracting temporal information and associated clinical context from the anonymized documents, organizing events in sequential order with date/time stamps and descriptive context. Case manager AI module 140 may perform standard-of-care assessment by analyzing identified issues, determining likelihood levels (e.g., high, moderate, or low confidence) that deviations occurred, providing detailed reasoning based on clinical standards or guidelines, and anticipating counter-arguments that might be raised. In some implementations, case manager AI module 140 may evaluate causation from multiple perspectives, such as analyzing plausibility that identified issues contributed to adverse outcomes and analyzing alternative explanations for observed outcomes. Case manager AI module 140 may query data store 110 to identify relevant medical literature, clinical guidelines, or other reference materials related to the case content.

The module may verify citations by querying external resource 108 to confirm that identified literature references actually exist and are accurately described, implementing hallucination prevention protocols as described with reference to steps 420-422 in method 400 (FIG. 5). Case manager AI module 140 can structure the generated content according to HTML templates with defined sections such as executive summaries, detailed timelines in table formats, expert analyses organized by issue, causation evaluations, literature references, and disclaimers. In some embodiments, case manager AI module 140 may perform sanitization operations to remove citation brackets or other formatting artifacts prior to output generation. The preliminary reports, which contain only pseudonymized patient identifiers, can be stored in data store 110 for subsequent transmission to expert reviewers.

Following the AI analysis phase, method 200 can proceed to an expert review phase including steps 218 and 220, which can involve expert interface portal 118 and expert communication module 144. At step 218, server device 104 can present one or more preliminary reports to external domain experts for validation and feedback. In some embodiments, expert communication module 144 of expert interface portal 118 can be configured to transmit anonymized preliminary reports generated at step 216 to authenticated expert reviewers through web-based interfaces. Expert communication module 144 may generate notifications to experts via email, text message, or in-portal alerts indicating that reports are available for review. Experts can access expert interface portal 118 through web browsers on their computing devices, authenticate using credentials or federated identity systems, and view the anonymized preliminary reports through interactive user interfaces. The presented reports can display patient information in pseudonymized form only (e.g., initials and modified dates of birth), thereby maintaining privacy during external review. In some implementations, expert interface portal 118 may provide user interface elements enabling experts to annotate specific sections of reports, highlight agreements or disagreements with AI-generated content, add clinical reasoning or professional opinions, and provide structured feedback through forms or text input fields.

At step 220, server device 104 can receive expert feedback submitted through expert interface portal 118. In some embodiments, expert communication module 144 can be configured to capture validations, corrections, clinical opinions, or other input provided by expert reviewers and store the feedback in data store 110. Expert feedback may include confirmations that AI-generated assertions are accurate, corrections of factual errors or misinterpretations in the preliminary report, alternative clinical reasoning or interpretations, professional opinions regarding standard-of-care compliance, causation assessments including percentage likelihood estimates when applicable, identification of missing information or analyses, and recommendations for additional considerations. In some implementations, expert communication module 144 may timestamp feedback submissions, associate feedback with specific expert identifiers while maintaining expert anonymity in downstream outputs, and link feedback to corresponding sections or assertions within the preliminary reports. The captured expert feedback can be structured using defined schemas or formats that facilitate automated processing in subsequent reconciliation steps. In some embodiments, server device 104 may generate notifications to client device 102 indicating that expert review has been completed and that final report generation can proceed.

Method 200 can then proceed to a report generation phase including steps 222 through 228, which can be executed by report generator module 120. At step 222, server device 104 can configure a reconciliation prompt for synthesizing final reports incorporating expert feedback. In some embodiments, reconciliation module 146 of report generator module 120 can be configured to load system instructions that define the AI's role as a medical editor and forensic fact-checker, establish source hierarchy rules treating expert feedback as authoritative for conflict resolution, mandate expert anonymity in outputs by using generic specialty descriptors rather than expert names, require single-opinion synthesis when multiple experts provide feedback, specify strict formatting protocols for court-ready documents, and implement zero-hallucination protocols with enhanced verification requirements. In some implementations, the prompt configuration loaded at step 222 may correspond to the detailed prompt structure and configuration procedures described with reference to method 500 in FIG. 6. The configured reconciliation prompt can establish the processing logic and constraints for synthesizing multiple input sources into unified final outputs.

At step 224, server device 104 can reconcile the preliminary report with expert feedback and source documents to generate synthesized content. In some embodiments, reconciliation module 146 can receive as inputs the preliminary report generated at step 216, expert feedback captured at step 220, and original source documents (in anonymized form) from data store 110. Reconciliation module 146 may execute algorithms to identify discrepancies between the preliminary report and expert feedback, such as detecting assertions in the preliminary report that contradict expert input, identifying additional information provided by experts that was not present in the preliminary report, or recognizing areas where experts expressed uncertainty or requested additional analysis. In some implementations, when multiple experts have provided feedback for the same case, reconciliation module 146 may synthesize the inputs into a unified opinion by identifying areas of agreement, detecting conflicts between expert opinions, and applying resolution logic such as majority voting, confidence-weighted aggregation, or flagging for manual review when experts provide irreconcilable conflicting assessments. Reconciliation module 146 can apply source hierarchy rules wherein expert feedback is treated as authoritative and overwrites contradictory AI-generated content, while factual assertions (e.g., dates, diagnoses, treatments) are verified against original source documents to ensure accuracy. In some embodiments, reconciliation module 146 may compute semantic similarity scores between preliminary report assertions and expert feedback using sentence embedding models to distinguish substantive conflicts from stylistic variations. Reconciliation module 146 may construct directed acyclic graph (DAG) representations of factual assertions with dependency relationships, perform topological sorting to process assertions in logical dependency order, and apply conflict resolution logic at each node. The module can verify literature citations with enhanced stringency compared to step 216, querying external resource 108 to confirm article existence, retrieve metadata such as journal impact factors, check retraction status, and validate relevance to case content as described with reference to steps 514-516 in method 500 (FIG. 6). Reconciliation module 146 can draft final report sections including executive summaries incorporating expert opinions, key findings with expert validations, detailed timelines verified against source documents, expert analysis and causation assessments reflecting validated content, and verified literature references. In some embodiments, reconciliation module 146 may apply professional tone requirements to ensure neutral language, incorporate expert-provided percentage likelihood estimates when available, and maintain objective framing suitable for legal contexts. The reconciled content, still containing pseudonymized patient identifiers at this stage, can be prepared for de-anonymization and final formatting.

At step 226, server device 104 can restore patient identification information in the reconciled report. In some embodiments, de-anonymization module 148 of report generator module 120 can be configured to retrieve cryptographic mapping tables from data store 110 that associate pseudonymized representations with original PHI elements. De-anonymization module 148 may perform hash table lookups or database queries to retrieve original patient names, accurate dates of birth, and other identifying information that was pseudonymized at step 210. The module can replace pseudonymized representations (e.g., initials, modified dates) with corresponding original PHI elements throughout the reconciled report. In some implementations, de-anonymization module 148 may perform checksum verification or cryptographic signature validation to ensure data integrity during restoration operations, confirming that retrieved original PHI elements have not been corrupted or tampered with during storage. De-anonymization module 148 may generate audit log entries documenting the de-anonymization operation, including timestamps, user identifiers, case identifiers, and PHI elements that were restored, which can be stored in data store 110 for compliance and security auditing purposes. The de-anonymized report, now containing full patient identification suitable for attorney use, can be passed to formatting operations.

At step 228, server device 104 can generate a final report in a distribution format. In some embodiments, report formatting module 150 of report generator module 120 can be configured to apply structured templates to the de-anonymized, reconciled report content and convert the formatted output to portable document format (PDF) or other distribution formats. Report formatting module 150 may apply HTML and CSS templates defining typography specifications such as font families (e.g., Times New Roman), font sizes, line spacing, and text styling; layout specifications such as page dimensions (e.g., letter size 8.5″×11″), margins (e.g., 1-inch margins), headers, and footers; table formatting for chronological timelines or other tabular content; and section organization including title pages, headers identifying recipients and authors, executive summaries, detailed analysis sections, literature references, and disclaimers. In some implementations, report formatting module 150 may perform sanitization operations to remove any remaining internal citation markers, validate character encoding to ensure compatibility with PDF rendering engines, and verify completeness of required report sections. Report formatting module 150 can invoke PDF conversion engines such as WeasyPrint, wkhtmltopdf, Puppeteer, or cloud-based conversion services to render the HTML content as a PDF document. The generated PDF can include metadata such as document title, author, creation date, and security settings such as encryption or permission restrictions when applicable. In some embodiments, report formatting module 150 may perform quality validation on the generated PDF, such as verifying page count, checking for rendering errors, confirming text searchability, or validating that no content was truncated during conversion. The final PDF report can be stored in data store 110 and transmitted to client device 102 via network 106, where it may be downloaded through web-based interfaces, delivered via email, or accessed through application interfaces. In some implementations, server device 104 may generate notifications to users at client device 102 indicating that final report generation is complete and the document is available for retrieval.

Following the report generation phase, method 200 can proceed to a continuous improvement phase including step 230, which can be executed by feedback loop module 152. At step 230, server device 104 can update AI models based on expert feedback to enable continuous improvement of analysis accuracy. In some embodiments, feedback loop module 152 can be configured to analyze expert feedback captured at step 220 and reconciliation operations performed at step 224 to identify systematic discrepancies between AI-generated content and expert-validated content. Feedback loop module 152 may extract correction pairs from reconciliation logs stored in data store 110, wherein each correction pair includes an input text segment from anonymized documents, an AI-generated output that was determined to be incorrect or suboptimal based on expert feedback, and an expert-validated correct output. In some implementations, feedback loop module 152 may apply active learning heuristics to prioritize high-value corrections for model retraining, such as uncertainty sampling that prioritizes cases where AI models exhibited high confidence but experts contradicted the output (indicating systematic blind spots), diversity sampling using clustering techniques in embedding space to ensure correction pairs cover diverse clinical scenarios, or difficulty scoring that prioritizes complex reasoning corrections over simple factual corrections. Feedback loop module 152 may apply privacy-preserving transformations such as differential privacy noise injection to correction data prior to incorporation into training datasets, ensuring that individual case details cannot be reconstructed from aggregate training data while enabling statistical learning from correction patterns. In some embodiments, feedback loop module 152 can perform incremental fine-tuning of AI models using techniques such as low-rank adaptation (LoRA), adapter layers, or experience replay wherein training batches include both new correction pairs and samples from original training distributions to prevent catastrophic forgetting of previously learned capabilities. Feedback loop module 152 may implement controlled deployment procedures such as A/B testing frameworks, canary deployments that route a small percentage of new cases to updated models for performance evaluation, or shadow mode testing wherein updated models process cases in parallel with production models for comparison without affecting production outputs. In some implementations, feedback loop module 152 may compute performance metrics such as F1 scores for classification tasks, accuracy rates for factual assertions, hallucination rates for citation generation, or agreement rates with expert feedback, and may apply statistical significance testing to determine whether updated models demonstrate sufficient improvements to warrant full production deployment. Only models that achieve predefined performance thresholds with statistical significance can be promoted from testing to full production deployment. Through iterative execution of step 230 across multiple cases over time, the AI models utilized in steps 212-216 and 222-224 can achieve progressive improvements in accuracy, reduced hallucination rates, and increased alignment with expert domain knowledge.

Method 200 can conclude following completion of step 230, or in some embodiments may return to step 202 to process additional cases, thereby implementing the continuous improvement capabilities across multiple case processing cycles. The method provides a systematic workflow for automated document analysis with privacy preservation, expert validation, and quality assurance mechanisms that can address technical challenges in processing sensitive documents requiring domain expert review.

FIG. 4 illustrates a graphical user interface 300 configured to provide case portal management functionality for users of system 100. User interface 300 can be displayed on client device 102 and can provide interactive elements enabling users to create case portals, upload documents, monitor processing status, and access generated reports. In some embodiments, user interface 300 may be implemented as a web-based application accessible through web browsers, a native desktop application, a mobile application, or other client software executing on client device 102. User interface 300 can communicate with server device 104 via network 106 to transmit user inputs, upload documents, and retrieve status information or completed outputs.

User interface 300 can be presented on display screen 302, which may include a monitor, display panel, touchscreen, or other visual output device associated with client device 102. In some embodiments, display screen 302 can render graphical elements including text, buttons, tables, forms, icons, and other user interface components using standard web technologies such as HTML, CSS, and JavaScript, or using native application frameworks. The layout and styling of elements on display screen 302 can be responsive to different screen sizes and device types, enabling consistent user experiences across desktop computers, laptops, tablets, and mobile devices.

User interface 300 can include navigation menu 304, which can provide selectable options for accessing different functional areas of the application. In some embodiments, navigation menu 304 may include options such as “Dashboard,” “Settings,” “Reports,” “Account,” or other navigation categories. As depicted in FIG. 4, the Dashboard option can be selected, indicating that the user is currently viewing the main dashboard interface displaying case portal information. Navigation menu 304 may be implemented as a horizontal menu bar, vertical sidebar, dropdown menu, or other navigational structure. In some implementations, selecting different options in navigation menu 304 can cause display screen 302 to render different views or interface panels without requiring full page reloads, which may be implemented using single-page application (SPA) architectures with client-side routing.

User interface 300 can include user identifier/sign out feature 306, which can display information about the currently authenticated user and provide functionality for terminating the user session. In some embodiments, user identifier/sign out feature 306 may display the user's name, username, email address, or other identifying information. The feature may include a selectable element such as a button, link, or dropdown menu that enables the user to sign out of the application, which can terminate the authenticated session and return the user to a login screen. In some implementations, user identifier/sign out feature 306 may also provide access to account settings, profile management, or other user-specific functions through dropdown menus or modal dialogs.

User interface 300 can include message field 308, which can display personalized messages, notifications, system status information, or instructional content to the user. In some embodiments, message field 308 may display a greeting message such as “Welcome back, Mathais!” as shown in FIG. 4, which can provide a personalized user experience by incorporating the user's name retrieved from authentication credentials or user profile data. Message field 308 may also display system announcements, alerts regarding case processing status changes, notifications of new expert feedback availability, or instructional text guiding users through workflows. In some implementations, message field 308 can dynamically update to reflect current system state or user actions, and may include dismissible notification elements, priority indicators, or timestamps.

User interface 300 can include portal creation feature 310, which can enable users to create new case portals for document processing and analysis. In some embodiments, portal creation feature 310 may be implemented as a virtual button, selectable element, or interactive control that, when activated, initiates a workflow for creating a new secure case folder within system 100. Each case portal can represent a distinct case or matter, with associated documents, processing outputs, and metadata maintained separately from other portals. In some implementations, activating portal creation feature 310 may cause display screen 302 to present a form or dialog requesting case-identifying information such as patient name, case reference number, incident date, or other metadata that can be used to label and organize the portal. Upon completion of the creation workflow, server device 104 can establish a new case record in data store 110, generate unique identifiers for the portal, configure security permissions, and prepare the portal to receive document uploads. In some embodiments, files associated with case portals can be stored in a HIPAA-compliant system with encryption applied both in transit during transmission over network 106 and at rest within data store 110, ensuring protection of sensitive health information.

User interface 300 can include portal identification field 312, which can display a table, list, or other structured presentation of existing case portals associated with the user's account or organization. In some embodiments, portal identification field 312 may present each case portal as a row in a table format, with columns displaying relevant metadata and status information. The table can include sortable columns that enable users to organize portal listings by different criteria. Portal identification field 312 can provide an overview of all active cases, enabling users to quickly locate specific portals, monitor processing status, and access case-specific functions.

Portal identification field 312 can include last name identifier 314, which can display the last name of the patient or subject associated with each case portal. In some embodiments, last name identifier 314 may be implemented as a sortable column header and associated data cells within a table structure. Users can activate sorting functionality by selecting the last name identifier 314 column header, which can cause the portal listing to be reordered alphabetically by last name in ascending or descending order. The last name data can be retrieved from case metadata stored in data store 110 when the portal was created or subsequently updated.

Portal identification field 312 can include first name identifier 316, which can display the first name of the patient or subject associated with each case portal. In some embodiments, first name identifier 316 may function similarly to last name identifier 314, providing both display and sorting capabilities. In some implementations, the combination of first name identifier 316 and last name identifier 314 can provide sufficient information for users to distinguish between different cases and locate specific portals of interest.

Portal identification field 312 can include date created identifier 318, which can display the timestamp or date when each case portal was created. In some embodiments, date created identifier 318 may be formatted according to configurable date/time display preferences, such as MM/DD/YYYY format, YYYY-MM-DD format, or formats including time-of-day information. Date created identifier 318 can provide sortable functionality enabling users to organize portals chronologically, which may be useful for identifying recently created cases or locating older cases based on temporal criteria. The date created information can be automatically recorded by server device 104 when a new portal is established through portal creation feature 310.

Portal identification field 312 can include action identifier 320, which can display available actions, current status, or interactive controls associated with each case portal. In some embodiments, action identifier 320 may present different information depending on the processing state of the case. For newly created portals that have not yet received document uploads, action identifier 320 may display a button or link labeled “Upload Documents” or similar text, indicating that the next step is to upload case files. For portals where documents have been uploaded and processing is in progress, action identifier 320 may display status indicators such as “Processing,” “Awaiting Expert Review,” or progress indicators showing completion percentages. For portals where preliminary reports have been generated and transmitted to experts, action identifier 320 may display “Expert Review in Progress” or similar status text. For portals where expert feedback has been received and final reports are available, action identifier 320 may display “Review Report,” “Download Final Report,” or similar action options.

In some implementations, action identifier 320 may also indicate when experts have submitted follow-up questions requiring attorney response, displaying text such as “Expert Questions—Response Needed.” Action identifier 320 can provide interactive elements such as buttons or links that, when activated, navigate the user to relevant interfaces for performing the indicated actions, such as document upload interfaces, report viewing interfaces, or question response forms.

User interface 300 can include upload documents feature 322, which can enable users to select and upload document files to specific case portals. In some embodiments, upload documents feature 322 may be implemented as a virtual button, link, or interactive element associated with each portal row in portal identification field 312, or as a dedicated interface accessed by selecting a portal and navigating to an upload function. When activated, upload documents feature 322 may cause display screen 302 to present a file selection dialog enabling users to browse their local file system and select one or more documents for upload. In some implementations, upload documents feature 322 may support various file formats including PDF, DOCX, JPEG, PNG, TIFF, or other formats supported by document processor module 112. Upload documents feature 322 may implement drag-and-drop functionality enabling users to drag files from file manager applications and drop them onto designated areas of user interface 300 for streamlined uploading. Upon file selection, upload documents feature 322 can transmit the selected files to server device 104 via network 106 using secure, encrypted connections. In some embodiments, upload documents feature 322 may display upload progress indicators showing percentage completion, file names being transmitted, or estimated time remaining for large file transfers. Following successful upload, server device 104 can initiate method 200 at step 202 to process the uploaded documents, and action identifier 320 for the corresponding portal can update to reflect the new processing status.

In some embodiments, user interface 300 can implement notification systems that alert users to important events or status changes related to their case portals. Notifications may be delivered through multiple channels including in-application notifications displayed within user interface 300 when the user is actively using the application, email notifications sent to the user's registered email address, text message notifications sent via SMS to the user's registered mobile phone number, or push notifications delivered to mobile applications. Notification triggers may include completion of document processing phases, availability of preliminary reports for review, receipt of expert feedback, completion of final reports, expert submission of follow-up questions, or system errors requiring user attention. In some implementations, users may configure notification preferences through settings interfaces accessible via navigation menu 304, enabling customization of which events trigger notifications and which delivery channels are used.

User interface 300 can enable various user interactions with case portals throughout the document processing lifecycle described in method 200. Upon creating a portal through portal creation feature 310 and uploading documents through upload documents feature 322, users can monitor processing progress through status updates displayed in action identifier 320. Following generation of case plans at step 214 of method 200, user interface 300 may present the case plan with identified specialty options, enabling users to select which specialty analyses should be generated. Following generation of preliminary reports at step 216, user interface 300 may provide interfaces for reviewing the preliminary reports prior to transmission to experts, or may automatically transmit reports to expert interface portal 118 based on configured workflows. Following receipt of expert feedback at step 220, user interface 300 may display notifications and provide access to review expert comments. Following generation of final reports at step 228, user interface 300 can provide download functionality enabling users to retrieve the court-ready PDF documents for use in legal proceedings. In some embodiments, user interface 300 may maintain historical records of all reports, versions, and communications associated with each portal, enabling users to access audit trails or review prior outputs.

The graphical user interface depicted in FIG. 4 provides an intuitive, efficient mechanism for users at client device 102 to interact with the document processing capabilities of system 100, enabling streamlined case management, document uploads, status monitoring, and output retrieval through a visually organized dashboard interface.

FIG. 5 illustrates a flowchart of method 400, which provides detailed procedures for configuring a case manager prompt and generating preliminary reports, corresponding to steps 212 and 216 of method 200 described with reference to FIG. 3. Method 400 can be executed by case manager AI module 140 and triage module 142 of AI analysis module 116 within server device 104. In some embodiments, method 400 can be invoked following completion of the anonymization phase of method 200, specifically after anonymized documents have been generated and stored in data store 110 at step 210. Method 400 can implement procedures for loading AI system instructions, configuring operational parameters, receiving inputs, generating structured analytical outputs, and iterating across multiple specialty domains when applicable. The steps of method 400 are described below in logical sequence, though certain operations may be performed in parallel or with variations in ordering depending on implementation details.

At step 402, server device 104 can load a case manager prompt including system instructions for artificial intelligence-based document analysis. In some embodiments, case manager AI module 140 can retrieve prompt configuration data from data store 110, configuration files stored on mass storage device 182, or other persistent storage locations. The case manager prompt can include structured instructions that define the operational role of the AI model, such as instructions to function as a senior case manager, domain expert, or analytical reviewer. In some implementations, the prompt may include role descriptions specifying that the AI should analyze medical documents, identify relevant clinical events, assess compliance with standards of care, evaluate causation relationships, and generate structured preliminary reports. The loaded prompt can establish the foundational instructions that govern AI behavior throughout subsequent steps of method 400.

At step 404, server device 104 can configure core directives that establish non-negotiable operational constraints for the AI model. In some embodiments, case manager AI module 140 can implement directives including zero-hallucination protocols, privacy protection requirements, tone specifications, and formatting mandates. Zero-hallucination protocols can include instructions prohibiting the AI from fabricating citations, references, or factual assertions not present in source documents, requiring verification of external references, and mandating flagging or removal of unverified content. Privacy protection directives can include requirements to use only pseudonymized identifiers when referencing patients or other individuals, prohibitions on using full names or accurate dates of birth, and instructions to replace personal names with generic descriptors. Tone specifications can define clinical authoritative language characteristics, neutral and objective phrasing requirements, and avoidance of hyperbolic or conclusory language. Formatting mandates can specify output structure requirements such as HTML format with defined sections, table structures for chronological timelines, and styling specifications. In some implementations, the configured core directives can be embedded within the prompt instructions passed to the large language model during inference operations, establishing behavioral constraints that guide content generation.

At step 406, server device 104 can set privacy parameters that define anonymization display rules for AI-generated outputs. In some embodiments, case manager AI module 140 can configure parameters specifying that patient identification should use initials only, dates of birth should display modified values rather than actual values, physician names should be replaced with generic terms such as “Physician” or “Healthcare Provider,” family member names should be replaced with generic terms such as “Relative,” and other personal identifiers should be omitted or genericized. The privacy parameters can reference the pseudonymization mappings generated at step 210 of method 200, ensuring consistency between the anonymization applied to source documents and the anonymization maintained in AI-generated preliminary reports. In some implementations, privacy parameters may include instructions regarding which clinical details can be preserved (e.g., diagnoses, treatments, medications) and which must be generalized (e.g., specific hospital names may be replaced with “Hospital” or “Medical Center”). These parameters can ensure HIPAA compliance and privacy protection during the preliminary report phase when reports will be transmitted to external experts through expert interface portal 118.

At step 408, server device 104 can configure formatting protocol specifications that define the structure and styling of AI-generated outputs. In some embodiments, case manager AI module 140 can load HTML and CSS template specifications defining report structure including header sections, executive summary sections, detailed timeline sections, expert analysis sections, causation evaluation sections, literature reference sections, and disclaimer sections. The formatting protocol can specify table structures for chronological timelines with columns for date/time information and event/clinical context descriptions, styling parameters such as font families, sizes, colors, spacing, and alignment, heading hierarchies and section organization, and requirements for clean HTML output without extraneous formatting artifacts. In some implementations, the formatting protocol can include a citation bracket removal requirement specifying that all internal citation markers such as [1], [2], (Source A), or similar bracketed references must be stripped from final output to ensure clean rendering when the HTML is converted to PDF or displayed in web interfaces. The configured formatting protocol can establish the presentation standards that govern how analytical content generated in subsequent steps will be structured and styled.

At step 410, server device 104 can receive anonymized records that will serve as the input data for AI analysis. In some embodiments, case manager AI module 140 can retrieve anonymized document text from data store 110, where the text was stored following processing at step 210 of method 200. The anonymized records can include textual content extracted from uploaded documents with PHI elements replaced by pseudonymized representations as described with reference to pseudonymization module 138. In some implementations, case manager AI module 140 may process the anonymized text to identify document boundaries, section headings, temporal markers, or other structural elements that can facilitate subsequent analysis operations. The anonymized records can be loaded into memory structures, tokenized for processing by the large language model, or otherwise prepared for inference operations.

At step 412, server device 104 can receive user specialty selection input indicating which domain-specific analyses should be generated. In some embodiments, the specialty selection may be received from client device 102 through user interface 300, as described with reference to FIG. 4, where a user may have been presented with a case plan generated at step 214 of method 200 listing multiple potential specialty domains relevant to the case. The user may select one or more specialties such as cardiology, emergency medicine, obstetrics and gynecology, anesthesiology, radiology, surgery, or other medical specialties for which preliminary expert reports should be generated. In some implementations, the user may select an “All” option indicating that reports should be generated for all identified relevant specialties. Case manager AI module 140 can receive the specialty selection input via network 106 and can initialize processing variables to track which specialties have been processed and which remain to be processed, facilitating the iterative loop structure described with reference to step 434.

Following receipt of inputs at steps 410 and 412, method 400 can proceed to a report generation phase including steps 414 through 432, which can be executed iteratively for each selected specialty domain. At step 414, server device 104 can build a detailed timeline of relevant events extracted from the anonymized records. In some embodiments, case manager AI module 140 can analyze the anonymized document text to identify temporal references such as dates, times, relative temporal expressions (e.g., “the next day,” “two hours later”), or event sequences. The module can extract clinical events associated with temporal references, such as patient presentations, symptom onsets, diagnostic tests ordered or performed, test results received, diagnoses made, treatments administered, consultations requested, procedures performed, medication administrations, patient transfers, or clinical outcomes. In some implementations, case manager AI module 140 may organize extracted events in chronological order, resolving relative temporal references to absolute timestamps where possible, and may construct a structured timeline representation with entries including date/time fields and event description fields. The timeline can include clinical context for each event, such as vital signs measurements, symptom descriptions, clinical decision-making rationale documented in records, or other relevant contextual information. In some embodiments, the timeline may be formatted as an HTML table structure with two columns, one containing date/time information and the other containing event descriptions with clinical context, conforming to the formatting protocol configured at step 408.

At step 416, server device 104 can analyze standard of care compliance for identified clinical issues. In some embodiments, case manager AI module 140 can identify potential deviations from accepted medical standards based on analysis of the chronological timeline, clinical events, and documented decision-making. For each potential deviation or issue, the module can assess the likelihood that a breach of standard of care occurred, which may be expressed using confidence levels such as “High,” “Moderate,” or “Low” confidence, or using probability ranges. The module can provide detailed clinical reasoning explaining why the identified issue may constitute a breach, which may reference established clinical guidelines, standard protocols, medical literature, or accepted medical practices relevant to the specialty domain being analyzed. In some implementations, case manager AI module 140 may anticipate potential defense arguments that might be raised to challenge the breach assertion, such as arguing that the clinical situation presented unusual circumstances, that alternative treatment approaches were medically reasonable, that information available to clinicians at the time was limited, or that the patient's condition precluded certain interventions. The module can also generate counter-arguments addressing anticipated defense positions, thereby providing comprehensive analysis useful for legal strategy development. The standard of care analysis can be structured with separate subsections for each identified issue, organized according to the formatting protocol configured at step 408.

At step 418, server device 104 can evaluate causation relationships between identified standard of care deviations and patient outcomes. In some embodiments, case manager AI module 140 can analyze causation from multiple perspectives to provide balanced assessment. From a plaintiff's perspective, the module can evaluate the plausibility that earlier intervention, different treatment decisions, or compliance with standard protocols would have improved patient outcomes, which may include analyzing “loss of chance” arguments wherein delays or omissions reduced the probability of favorable outcomes even if the ultimate outcome might have occurred regardless. From a defense perspective, the module can evaluate the plausibility of “inevitable outcome” arguments wherein the patient's underlying condition, disease progression, or other factors would have led to the observed outcome regardless of the identified deviations, such that the deviations did not proximately cause the harm. In some implementations, case manager AI module 140 may assess the strength of causation linkages using qualitative descriptors such as “strong causation linkage,” “moderate causation linkage,” or “weak causation linkage,” or may provide probabilistic assessments. The causation evaluation can incorporate analysis of temporal relationships between interventions and outcomes, consideration of alternative causal pathways, and discussion of medical literature supporting or refuting causation theories. The causation analysis can be formatted according to the HTML template specifications configured at step 408.

At step 420, server device 104 can match medical literature relevant to the case content and analytical conclusions. In some embodiments, case manager AI module 140 can query data store 110 to identify peer-reviewed medical articles, clinical guidelines, consensus statements, or other authoritative medical literature related to the clinical issues, treatments, diagnoses, or causation theories being analyzed. The module may apply search criteria such as limiting results to publications from the last 10 years to ensure currency, prioritizing articles from high-impact journals such as New England Journal of Medicine, Journal of the American Medical Association, The Lancet, or specialty-specific high-impact journals, and selecting articles with methodological rigor such as systematic reviews, meta-analyses, randomized controlled trials, or large cohort studies. In some implementations, case manager AI module 140 may use semantic search techniques with vector embeddings to identify articles whose content is semantically similar to the case circumstances and analytical themes, rather than relying solely on keyword matching. The module can select a limited number of highly relevant articles, such as 1-3 articles per analytical section, to provide focused literature support without overwhelming the report with excessive references. Identified literature references can be formatted with citation information including author names, article titles, journal names, publication years, volume and issue numbers, and page ranges or digital object identifiers (DOIs).

At step 422, server device 104 can verify that identified literature citations actually exist and are accurately described. In some embodiments, case manager AI module 140 can implement hallucination prevention protocols by validating each literature reference generated at step 420 against external databases. The module may query external resource 108, such as PubMed databases accessible via application programming interfaces, to confirm that articles with the specified citation information exist in authoritative repositories. In some implementations, the verification process may include submitting structured queries including author surnames, journal abbreviations, publication years, and title keywords to external resource 108, receiving responses containing article metadata and unique identifiers such as PubMed IDs (PMIDs), and comparing the received metadata against the AI-generated citation information to confirm accuracy. Case manager AI module 140 may perform fuzzy matching on article titles to account for minor variations in AI-generated titles compared to official article titles, which may use Levenshtein edit distance calculations with defined thresholds. The module may also verify that article abstracts retrieved from external resource 108 are semantically relevant to the case context in which the article is being cited, which may involve computing cosine similarity scores between abstract embeddings and case context embeddings. In some embodiments, citations may be assigned confidence scores based on verification results, where citations that pass all verification checks receive high confidence scores (e.g., ≥0.85), citations with minor discrepancies receive moderate confidence scores (e.g., 0.60-0.84), and citations that fail external verification receive low confidence scores (e.g., <0.60).

Case manager AI module 140 can evaluate the confidence scores assigned to each citation and can determine whether all citations meet a predefined threshold such as 0.85 or higher. If one or more citations fail verification or receive low confidence scores, case manager AI module 140 can flag the unverified citations with disclaimer text such as “Citation pending verification,” “Reference subject to confirmation,” or similar cautionary language. In some implementations, unverified citations may be retained with disclaimers in preliminary reports because the reports will be reviewed by expert physicians who can identify and correct any erroneous references, whereas in final reports generated by method 500 (FIG. 6), unverified citations may be removed entirely to ensure court-ready accuracy. Following citation verification and any necessary flagging operations, method 400 can proceed to step 426.

At step 426, server device 104 can apply an HTML template to structure the generated analytical content into a formatted preliminary report. In some embodiments, case manager AI module 140 can organize the content generated in steps 414-422 according to the template specifications configured at step 408. The module can construct an HTML document including a header block containing metadata fields such as “To:” field identifying the recipient (e.g., client firm name), “From:” field identifying the sender (e.g., system name or organization), “Date:” field with the report generation date, “Subject:” field describing the report purpose, “Patient:” field with pseudonymized patient identifiers (initials and modified date of birth), and “Reviewing Expert:” field indicating the specialty domain (e.g., “Board-Certified Expert in Cardiology”). The HTML document can include a Section I labeled “Executive Summary” containing a high-level overview of the breach assessments and causation conclusions, a Section II labeled “Detailed Timeline” containing the chronological event table generated at step 414, a Section III labeled “Expert Analysis of Allegations” containing the standard of care analysis generated at step 416, a Section IV labeled “Causation & Literature” containing the causation evaluation from step 418 and literature references from steps 420-422, and a disclaimer section containing text such as “This is a preliminary analysis generated with AI assistance and subject to expert physician review. This document does not constitute final expert testimony.” In some implementations, case manager AI module 140 can apply CSS styling specifications to define fonts, colors, spacing, table borders, heading styles, and other visual formatting parameters conforming to the formatting protocol configured at step 408.

At step 428, server device 104 can enforce privacy compliance by verifying that the generated HTML report contains only pseudonymized identifiers. In some embodiments, case manager AI module 140 can perform a final verification pass over the generated HTML content to confirm that patient identification uses initials only and does not include full names, that dates of birth display modified values consistent with the pseudonymization performed at step 210 of method 200 and do not display actual dates of birth, that no full names of physicians, family members, or other individuals appear in the document, and that generic descriptors such as “Physician,” “Relative,” or “Healthcare Provider” are used in place of personal names. In some implementations, the privacy compliance verification may use pattern matching techniques to detect potential privacy violations such as regex patterns matching full name formats (e.g., capitalized words in sequence without generic medical terms), Social Security Numbers, phone numbers, email addresses, or other PHI elements that should have been anonymized. If privacy violations are detected, case manager AI module 140 may apply corrective transformations to replace the violating content with appropriate pseudonymized representations, may log the violation for quality assurance review, or may halt processing and generate error notifications. Upon successful verification that all privacy requirements are satisfied, method 400 can proceed to step 430.

At step 430, server device 104 can remove citation brackets and other internal markers from the HTML output. In some embodiments, case manager AI module 140 can perform sanitization operations to strip all bracketed citation markers such as [1], [2], [3], (Source A), (Source B), or similar reference notation that may have been used internally during content generation but should not appear in the final formatted output. The removal of citation brackets can be implemented using regular expression substitution operations that identify and delete patterns matching common citation bracket formats. In some implementations, this sanitization step can be important for ensuring clean HTML rendering and subsequent PDF conversion, as residual bracketed markers may cause formatting inconsistencies, confuse readers, or interfere with document conversion processes. The sanitization operation can produce clean HTML output suitable for presentation to expert reviewers through expert interface portal 118.

At step 432, server device 104 can output the preliminary report for transmission to expert reviewers. In some embodiments, case manager AI module 140 can store the completed HTML preliminary report in data store 110 with associated metadata such as case identifiers, specialty domain identifiers, generation timestamps, and version numbers. The module can transmit the preliminary report to expert interface portal 118 for presentation to board-certified physician reviewers in the relevant specialty domain, as described with reference to step 218 of method 200 (FIG. 3). In some implementations, case manager AI module 140 may generate notifications to expert communication module 144 indicating that a new preliminary report is available for expert review, which can trigger notification delivery to assigned expert reviewers via email, text message, or in-portal alerts. The preliminary report output at step 432 can serve as the input for the expert review phase described in steps 218-220 of method 200.

Following output of the preliminary report at step 432, method 400 can proceed to step 434, which includes a decision point determining whether additional specialties remain to be processed. In some embodiments, case manager AI module 140 can evaluate whether the user specialty selection received at step 412 specified multiple specialty domains and whether all selected specialties have been processed through the report generation loop including steps 414-432. If additional specialties remain to be processed (YES branch), method 400 can loop back to step 414 to generate a preliminary report for the next specialty domain. In some implementations, the loop iteration may involve retrieving the next specialty identifier from the user selection, configuring specialty-specific analytical parameters or criteria, and executing steps 414-432 with focus on the clinical issues, standards of care, and literature relevant to the new specialty domain. For example, if the user selected both cardiology and emergency medicine specialties, case manager AI module 140 may first process cardiology (first iteration through steps 414-432), then loop back to process emergency medicine (second iteration through steps 414-432). The iterative loop structure can enable efficient generation of multiple specialty-specific preliminary reports from the same set of anonymized source documents. If no additional specialties remain to be processed (NO branch), indicating that all selected specialty analyses have been completed, method 400 can conclude and can return control to method 200, which may proceed to step 218 to present the generated preliminary reports to expert reviewers.

Method 400 provides detailed procedures for configuring AI system instructions, implementing operational constraints including privacy protection and hallucination prevention protocols, generating structured analytical content from anonymized medical documents, verifying literature references against external databases, and producing formatted preliminary reports suitable for expert physician review. The method enables scalable generation of specialty-specific analyses through iterative processing loops, while maintaining privacy compliance and factual accuracy through multi-stage verification mechanisms.

FIG. 6 illustrates a flowchart of method 500, which provides detailed procedures for configuring a reconciliation prompt and generating final reports by synthesizing preliminary AI-generated content with expert feedback and source documents, corresponding to steps 220, 222, and 224 of method 200 described with reference to FIG. 3. Method 500 can be executed by reconciliation module 146, de-anonymization module 148, and report formatting module 150 of report generator module 120 within server device 104. In some embodiments, method 500 can be invoked following completion of the expert review phase of method 200, specifically after expert feedback has been captured and stored in data store 110 at step 220. Method 500 can implement procedures for loading reconciliation system instructions, receiving multiple input sources, identifying and resolving conflicts between sources, verifying factual accuracy, restoring patient identification, generating final report content, and producing court-ready PDF documents. The steps of method 500 are described below in logical sequence, though certain operations may be performed in parallel or with variations in ordering depending on implementation details.

At step 502, server device 104 can load a reconciliation engine prompt including system instructions for synthesizing multiple data sources into unified final outputs. In some embodiments, reconciliation module 146 can retrieve prompt configuration data from data store 110, configuration files, or other storage locations. The reconciliation engine prompt can include structured instructions that define the operational role of the AI model as a medical editor and forensic fact-checker responsible for producing court-ready documents with zero tolerance for factual inaccuracies. In some implementations, the loaded prompt can establish source hierarchy rules wherein expert feedback is treated as the authoritative source of truth for resolving conflicts with AI-generated content, while factual assertions such as dates, diagnoses, or treatments are verified against original source documents. The prompt can mandate expert anonymity requirements specifying that expert reviewers should be referenced using generic descriptors such as “Board-Certified Expert in [Specialty]” rather than personal names, thereby protecting expert identities in final outputs. The prompt can require single-opinion synthesis when multiple experts have provided feedback for the same case, necessitating consolidation of potentially divergent expert views into unified assessments. In some embodiments, the reconciliation prompt can specify strict formatting protocols for court-ready documents and can implement enhanced zero-hallucination protocols with more stringent verification requirements than the preliminary report phase, reflecting the higher accuracy standards required for attorney-facing documents that may be used in legal proceedings. The loaded prompt can establish the foundational instructions governing AI behavior throughout subsequent steps of method 500.

At step 504, server device 104 can receive inputs from multiple sources that will be synthesized during the reconciliation process. In some embodiments, reconciliation module 146 can retrieve three primary input categories from data store 110. The first input can include the preliminary report generated at step 432 of method 400 (FIG. 5), which contains AI-generated timelines, standard of care analyses, causation evaluations, and literature references in anonymized form. The second input can include expert feedback captured at step 220 of method 200 (FIG. 3), which may include expert validations confirming accuracy of AI-generated content, expert corrections identifying errors or misinterpretations in the preliminary report, expert opinions providing clinical reasoning or professional assessments, causation assessments that may include percentage likelihood estimates, identification of missing information or additional considerations, and recommendations for alternative analytical approaches. The third input can include source medical records in anonymized form, which were processed and stored at step 210 of method 200, providing the original factual basis against which all assertions can be verified. In some implementations, reconciliation module 146 may also retrieve the cryptographic mapping tables generated during anonymization at step 210, which will be used for de-anonymization operations at step 510. The aggregation of these multiple input sources at step 504 can prepare the data required for subsequent reconciliation and synthesis operations.

At step 506, server device 104 can identify and resolve discrepancies between the preliminary report and expert feedback. In some embodiments, reconciliation module 146 can execute comparison algorithms to detect conflicts between AI-generated assertions and expert input. The module may identify substantive discrepancies such as instances where the preliminary report asserted a breach of standard of care but the expert feedback indicated no breach occurred, instances where the preliminary report omitted clinically significant events that the expert identified as important, instances where the preliminary report's causation analysis contradicted the expert's causation opinion, or instances where timeline events were described inaccurately according to expert assessment. In some implementations, when multiple experts have provided feedback for the same case, reconciliation module 146 may synthesize the multiple expert inputs into a unified opinion by identifying areas where experts agree and consolidating those agreements into single statements, detecting areas where experts disagree and applying resolution logic such as majority consensus when three or more experts are involved, confidence-weighted aggregation based on expert-provided certainty levels, or flagging for manual review when experts provide irreconcilable contradictory assessments.

Reconciliation module 146 can apply source hierarchy rules to resolve conflicts, wherein expert feedback overwrites contradictory AI-generated content based on the principle that domain expert assessment constitutes the authoritative source for clinical and professional judgments. In some embodiments, reconciliation module 146 may compute semantic similarity scores using sentence embedding models to distinguish between substantive conflicts and mere stylistic or phrasing variations that do not represent true disagreements. The module may construct directed acyclic graph (DAG) data structures representing factual assertions and their dependency relationships, perform topological sorting to process assertions in logical dependency order, and apply conflict resolution logic at each node based on the configured source hierarchy. The discrepancy resolution process can produce a reconciled content structure that integrates expert corrections and validations with the foundational analytical framework from the preliminary report.

At step 508, server device 104 can verify facts against source records to ensure accuracy of all factual assertions in the reconciled content. In some embodiments, reconciliation module 146 can cross-reference every factual statement including dates of clinical events, times associated with interventions or observations, patient medical history elements such as prior diagnoses or chronic conditions, clinical events such as diagnostic tests ordered or performed, treatments administered such as medication dosages and administration times, diagnoses documented by healthcare providers, and patient outcomes or clinical status changes against the original source medical records retrieved as inputs at step 504. The verification process can involve extracting relevant text segments from source documents that support or contradict each factual assertion, computing evidence scores using ranking algorithms such as BM25 or semantic similarity measures to quantify the strength of documentary support for each assertion, and flagging assertions that lack sufficient documentary support or that contradict source documentation. In some implementations, reconciliation module 146 may prioritize expert feedback when conflicts arise between expert statements and source document interpretations, recognizing that experts may provide clinical context or interpretations that go beyond literal document text. However, for objective factual elements such as timestamps or documented diagnoses, the source documents can serve as the authoritative reference. The fact verification process can ensure that the final report contains only assertions that are either directly supported by source documentation or explicitly identified as expert professional opinions, thereby minimizing the risk of including unsupported or fabricated content.

At step 510, server device 104 can restore patient identification information in the reconciled content. In some embodiments, de-anonymization module 148 can retrieve the cryptographic mapping tables from data store 110 that associate pseudonymized representations with original protected health information elements. The module can perform hash table lookups or database queries using the pseudonymized identifiers present in the reconciled content (e.g., patient initials, modified dates of birth) as keys to retrieve corresponding original PHI elements (e.g., patient full names, accurate dates of birth). De-anonymization module 148 can replace all pseudonymized representations throughout the reconciled content with the corresponding original information, transforming the report from privacy-protected form suitable for external expert review into fully identified form suitable for attorney use. In some implementations, de-anonymization module 148 may perform data integrity verification using checksum validation or cryptographic signature verification to ensure that retrieved original PHI elements have not been corrupted, modified, or tampered with during storage in data store 110. The module may generate audit log entries documenting the de-anonymization operation, including timestamps indicating when de-anonymization occurred, user identifiers indicating which user or system process initiated the operation, case identifiers specifying which case was de-anonymized, and lists of PHI elements that were restored. In some embodiments, the audit logs can be stored in data store 110 with cryptographic signatures or write-once storage configurations to provide tamper-evident records for regulatory compliance and security auditing purposes. The de-anonymized content, now containing full patient identification, can be prepared for final report drafting operations.

At step 512, server device 104 can draft final report sections incorporating the reconciled, verified, and de-anonymized content. In some embodiments, reconciliation module 146 can generate structured report components including an executive summary that provides a high-level overview of the case, synthesizes the expert's breach assessments with integrated clinical reasoning, presents causation conclusions incorporating expert opinions and percentage likelihood estimates when provided, and establishes the overall narrative framework for the report. The module can draft a key findings section including a bulleted or structured list of specific standard of care deviations that have been expert-validated or confirmations that care met applicable standards, highlighting the most significant clinical issues with concise descriptions. The module can draft a detailed timeline section organized in chronological table format with date/time columns and event/clinical context columns, incorporating events from the preliminary report timeline that have been validated by expert feedback, adding events identified by experts that were not in the preliminary report, correcting any timeline inaccuracies identified during expert review, and ensuring that all timeline entries are verified against source documents as performed at step 508. The module can draft an expert analysis and causation section that presents the medical reasoning explaining why identified issues constitute breaches or why care was appropriate, incorporates expert clinical judgment and professional opinions captured during expert review, articulates causation linkages between identified breaches and patient harm using both scientific reasoning and expert assessment, addresses alternative causation theories or defense arguments, and maintains attribution to the expert using generic specialty descriptors to preserve anonymity. In some implementations, the drafting process can apply professional tone requirements to ensure that language is measured, neutral, and appropriate for legal contexts, which may involve replacing hyperbolic terms with moderate alternatives, using probabilistic or qualified language such as “likely,” “may have,” “suggests,” or “appears to” rather than absolute statements, and maintaining objective framing that presents analysis rather than advocacy. The drafted sections can collectively form a comprehensive final report that synthesizes all input sources while maintaining factual accuracy and professional presentation standards.

At step 514, server device 104 can search for and verify medical literature relevant to the final report content. In some embodiments, reconciliation module 146 can query data store 110 to identify peer-reviewed medical literature that supports the expert-validated causation theories, standard of care analyses, or clinical reasoning presented in the drafted report sections. The search process can utilize semantic similarity techniques wherein queries include expert-validated causation statements or breach descriptions, and the system retrieves articles with high semantic similarity to the query content using vector embeddings and similarity measures such as cosine similarity. In some implementations, the module may apply filtering criteria including limiting results to publications within the last 10 years to ensure currency of medical knowledge, prioritizing articles from high-impact medical journals based on impact factor metrics, requiring peer-reviewed publication status and excluding preprints or conference abstracts, and selecting methodologically rigorous study types such as systematic reviews, meta-analyses, randomized controlled trials, or large observational studies. The module can select a limited number of highly relevant articles, such as 1-2 articles per major analytical theme, to provide focused literature support without excessive citation density. Following identification of candidate literature, reconciliation module 146 can verify each citation with enhanced stringency compared to the preliminary report phase. The verification process can include querying external resource 108 such as PubMed databases via application programming interfaces to confirm article existence by submitting article metadata and receiving confirmation responses with PubMed identifiers (PMIDs) or other unique identifiers, retrieving full article metadata including journal names, impact factors, publication dates, author affiliations, and abstracts, checking retraction status by querying retraction databases or services to ensure that cited articles have not been retracted or corrected in ways that invalidate their conclusions, validating relevance by computing semantic similarity between article abstracts and the case context in which articles are being cited to ensure thematic alignment, and performing conflict-of-interest analysis by comparing author affiliations against defendant institution names or involved parties to identify potential bias that should be disclosed or that may warrant citation exclusion. In some embodiments, the verification process can implement stricter acceptance criteria than step 422 of method 400 (FIG. 5), reflecting the higher reliability standards required for attorney-facing documents compared to preliminary reports subject to expert review.

At step 516, server device 104 can determine whether all literature citations have been successfully verified. In some embodiments, reconciliation module 146 can evaluate the verification results from step 514 to assess whether each candidate citation passed all verification checks including existence confirmation, metadata validation, retraction check, relevance validation, and conflict-of-interest screening. If all citations are verified successfully (YES branch), indicating that every literature reference has been confirmed to exist, is accurately described, has not been retracted, is relevantly related to case content, and does not present significant conflicts of interest, method 500 can proceed directly to step 518. If one or more citations fail verification checks (NO branch), indicating that some literature references could not be confirmed or failed one or more verification criteria, reconciliation module 146 can remove the unverified citations from the final report content. In some implementations, unlike the preliminary report phase where unverified citations might be flagged with disclaimers, the final report phase implements stricter quality controls by completely removing unverified references rather than including them with caveats, ensuring that the attorney-facing document contains only verified, reliable literature support. Following removal of unverified citations, method 500 can return to step 514 to search for alternative literature that can be verified, or if no alternative literature is available, may proceed to step 518 with a final report containing fewer literature citations but maintaining absolute accuracy. The decision logic at step 516 can implement quality gate controls that prevent inclusion of potentially fabricated or inaccurate citations in court-ready documents.

At step 518, server device 104 can apply professional tone requirements throughout the final report content. In some embodiments, reconciliation module 146 can review the drafted report sections from step 512 and verified literature from step 514 to ensure consistent application of neutral, measured, professional language appropriate for legal contexts. The module can replace or avoid hyperbolic adjectives such as “egregious,” “massive,” “shocking,” or “catastrophic” with objective descriptive terms, substitute absolute or conclusory language with qualified probabilistic language using terms such as “likely,” “may have contributed,” “suggests,” “appears consistent with,” or “plausible,” maintain clinical objectivity by presenting analysis and reasoning rather than advocacy or emotional language, and incorporate expert-provided percentage likelihood estimates when available to provide quantified assessments such as “The expert assesses a 70% likelihood that earlier intervention would have improved outcome.” In some implementations, the tone calibration can involve analyzing sentence structures, word choices, and rhetorical framing to ensure alignment with professional medical-legal communication standards. The application of professional tone requirements can enhance the credibility and persuasiveness of the final report by presenting expert-validated analysis in measured, objective language that is appropriate for presentation in legal proceedings or settlement negotiations.

At step 520, server device 104 can apply an HTML template to structure the final report content with court-ready formatting. In some embodiments, report formatting module 150 can construct an HTML document organizing the drafted, verified, and tone-calibrated content according to defined template specifications. The HTML document can include a header section containing structured metadata fields including “To:” field with the law firm or attorney name retrieved from case metadata, “From:” field identifying the report generator organization or system, “Date:” field with the final report generation date, “Subject:” field describing the report purpose and case identification, “Patient:” field with the patient's full name and accurate date of birth (de-anonymized at step 510), and “Reviewing Expert:” field identifying the expert by specialty using generic descriptor such as “Board-Certified Expert in Emergency Medicine” to maintain expert anonymity. The HTML document can include a Section I labeled “Executive Summary” containing the high-level synthesis drafted at step 512, a Section II labeled “Key Findings” containing the bulleted or structured findings list, a Section III labeled “Detailed Timeline” containing the chronological event table in HTML table format with appropriate column headers and styling, a Section IV labeled “Expert Analysis & Causation” containing the expert reasoning and causation assessment with integrated literature references, a literature references section listing the verified citations from step 514 with complete bibliographic information, and a disclaimer section containing text such as “This analysis was generated with AI assistance and reviewed by a board-certified expert physician. This document represents a preliminary assessment for attorney use and does not constitute final expert testimony for trial purposes.” In some implementations, report formatting module 150 can apply CSS styling specifications defining typography using fonts such as Times New Roman with 12-point font size, page layout specifications such as letter size (8.5 inches by 11 inches) with 1-inch margins on all sides, table formatting including borders, cell padding, and alternating row colors for readability, heading hierarchy with differentiated font sizes and weights for section headers, and spacing parameters including line height and paragraph spacing optimized for professional document appearance. The application of the HTML template can produce a structured, professionally formatted document ready for conversion to PDF.

At step 522, server device 104 can perform a sanitization pass to remove artifacts and validate character encoding. In some embodiments, report formatting module 150 can review the entire HTML document to identify and remove all bracketed citation markers such as [1], [2], (Source A), or similar internal reference notation that may have persisted from earlier processing stages. The sanitization process can utilize regular expression pattern matching to detect various bracket formats and delete them from the HTML content, ensuring clean presentation without confusing or extraneous markers. In some implementations, report formatting module 150 can verify character encoding to ensure that only web-safe ASCII characters are used throughout the document, replacing or removing special characters such as curly quotes that should be replaced with straight quotes, LaTeX symbols or mathematical notation that may not render correctly in PDF conversion, Unicode characters outside the standard ASCII range that could cause rendering issues, or other problematic character encodings. The sanitization pass can be important for ensuring successful HTML-to-PDF conversion, as certain character encodings or residual formatting artifacts can cause conversion failures, rendering errors, or unexpected visual anomalies in the final PDF document. In some embodiments, the sanitization operation can also remove HTML comments, debugging markup, or other non-display elements that are not intended for inclusion in the final output.

At step 524, server device 104 can perform a final quality check before PDF conversion and delivery. In some embodiments, report formatting module 150 can execute a comprehensive validation process to verify that the final report meets all quality standards. The quality check can verify zero hallucinations by confirming that all factual assertions regarding dates, times, diagnoses, treatments, or clinical events are supported by source documents or explicitly identified as expert opinions, confirming that all literature citations have been verified through the process described at steps 514-516, and ensuring that no fabricated references, case citations, or unsupported factual claims appear in the report.

The check can verify expert integration by confirming that expert feedback has been fully incorporated into the report content, that areas where experts corrected the preliminary report have been updated in the final version, and that expert opinions are properly attributed using generic specialty descriptors. The check can verify facts against source records by confirming that timeline entries, clinical events, and factual assertions align with source document content as validated at step 508. The check can verify absence of bracketed citations by confirming that the sanitization pass at step 522 successfully removed all internal citation markers. The check can verify proper patient identification restoration by confirming that the patient's full name and accurate date of birth appear in the report header, that no pseudonymized representations (initials or modified dates) remain in the final document, and that the de-anonymization process at step 510 was completed successfully. In some implementations, the quality check may be partially automated through script-based validation rules and partially manual through human reviewer verification. If quality check failures are detected, method 500 may iterate back to relevant steps for corrective action, such as returning to step 512 to correct content errors, returning to step 514 to address citation issues, or returning to step 522 to resolve sanitization problems. Only upon successful completion of all quality validation criteria can method 500 proceed to final conversion and delivery.

At step 526, server device 104 can convert the HTML final report to PDF format and deliver it to the requesting user. In some embodiments, report formatting module 150 can invoke PDF conversion engines or services such as WeasyPrint, wkhtmltopdf, Puppeteer with headless Chrome, or cloud-based HTML-to-PDF conversion services to render the sanitized, quality-checked HTML document as a PDF file. The PDF conversion process can preserve the visual formatting defined by the HTML and CSS specifications applied at step 520, including fonts, spacing, table structures, and page layouts. In some implementations, report formatting module 150 may configure PDF metadata including document title derived from case information, author identification, creation timestamp, and security settings such as encryption with password protection if required by user preferences or organizational policies, or permission settings restricting printing, copying, or editing if desired. Following successful PDF generation, report formatting module 150 can store the final PDF report in data store 110 with associated metadata including case identifiers, version numbers, generation timestamps, and file checksums for integrity verification. The module can transmit the PDF document to client device 102 via network 106 using secure, encrypted transmission protocols. In some implementations, the delivery mechanism may include making the PDF available for download through user interface 300 described with reference to FIG. 4, where the action identifier 320 for the relevant case portal can be updated to display options such as “Download Final Report” or “View Report,” sending an email notification to the user's registered email address with the PDF attached or with a secure download link, or providing API responses containing the PDF data or access URLs for programmatic retrieval by client applications. Report formatting module 150 may also generate notifications to client device 102 indicating that final report generation is complete and the document is available, which may be delivered through in-application notifications, email alerts, or text messages depending on user notification preferences configured through settings interfaces. In some embodiments, the system may maintain historical records of all generated report versions, enabling users to access prior iterations if multiple rounds of expert review and reconciliation have occurred.

Method 500 can conclude following successful PDF delivery at step 526. In some embodiments, the completion of method 500 may trigger execution of step 230 in method 200 (FIG. 3), wherein feedback loop module 152 analyzes the expert feedback and reconciliation operations from method 500 to extract correction pairs for continuous AI model improvement. Method 500 provides comprehensive procedures for synthesizing multiple input sources including preliminary AI-generated content, expert professional feedback, and original source documents into unified, court-ready final reports that maintain factual accuracy through multi-stage verification, incorporate expert domain knowledge through systematic reconciliation, restore patient identification for attorney use, and present analysis in professional, measured language appropriate for legal proceedings. The method implements stringent quality controls including enhanced citation verification, comprehensive fact checking, sanitization operations, and multi-criteria quality validation to ensure that final outputs meet the high reliability standards required for documents that may be used in settlement negotiations, motion practice, or trial proceedings.

FIG. 7 illustrates physical hardware components of server device 104, which was introduced with reference to FIG. 1 and whose functional software architecture was described with reference to FIG. 2. The physical hardware provides the computational infrastructure upon which the document processor module 112, anonymization module 114, AI analysis module 116, expert interface portal 118, report generator module 120, feedback loop module 152, and other software components execute. Server device 104 can include at least one central processing unit (CPU) 168, a system memory 176, and a system bus 174 that couples system memory 176 to CPU 168. In some embodiments, system memory 176 can include random-access memory (RAM) 178 and read-only memory (ROM) 180. A basic input/output system containing basic routines that help transfer information between elements within server device 104, such as during startup operations, can be stored in ROM 180. Server device 104 can further include mass storage device 182, which can store software instructions and data including the software modules described with reference to FIG. 2, such as file ingestion module 132, text extraction module 134, PHI identification module 136, pseudonymization module 138, case manager AI module 140, triage module 142, expert communication module 144, reconciliation module 146, de-anonymization module 148, report formatting module 150, and feedback loop module 152. Mass storage device 182 can also store data repositories including uploaded document files, extracted text content, cryptographic mapping tables, anonymized documents, preliminary reports, expert feedback, final reports, medical literature databases, AI model parameters and weights, training datasets, audit logs, and other data elements utilized by system 100. Physical hardware components similar to those shown in FIG. 7 may also be included in other computing devices within system 100, such as client device 102 or computing resources hosting expert interface portal 118 when implemented on separate infrastructure.

Mass storage device 182 can be connected to CPU 168 through a mass storage controller (not shown in FIG. 7) that is connected to system bus 174. Mass storage device 182 and its associated computer-readable data storage media can provide non-volatile, non-transitory storage for server device 104. Although the description of computer-readable data storage media contained herein may refer to mass storage devices such as hard disk drives or solid-state drives, it should be appreciated by those skilled in the art that computer-readable data storage media can include any available non-transitory physical device or article of manufacture from which server device 104 can read data and execute instructions. In some embodiments, mass storage device 182 can include solid-state drives (SSDs), NVMe (Non-Volatile Memory Express) storage devices, magnetic hard disk drives, hybrid drives combining solid-state and magnetic storage, or network-attached storage systems. Computer-readable data storage media can include volatile and non-volatile, removable and non-removable media implemented in any method or technology for storage of information such as computer-readable software instructions, data structures, program modules, or other data. Example types of computer-readable data storage media include, but are not limited to, RAM, ROM, erasable programmable read-only memory (EPROM), electrically erasable programmable read-only memory (EEPROM), flash memory or other solid-state memory technology, compact disc read-only memory (CD-ROM), digital versatile discs (DVDs), Blu-ray discs, other optical storage media, magnetic cassettes, magnetic tape, magnetic disk storage, or other magnetic storage devices, or any other non-transitory medium which can be used to store desired information and which can be accessed by server device 104. In some embodiments, RAM 178 can include memory regions allocated for active processing of documents during text extraction operations, memory buffers for optical character recognition processing, cached AI model parameters during inference operations, temporary storage for anonymized content during processing workflows, or shared memory structures facilitating inter-process communication between software modules described with reference to FIG. 2.

According to various embodiments, server device 104 may operate in a networked environment using logical connections to remote network devices through network 106, such as a local area network, wide area network, the Internet, virtual private network, wireless network, cellular network, or combinations thereof. Network 106 can provide wired and/or wireless connectivity between server device 104 and client device 102, enabling transmission of uploaded documents from client device 102 to server device 104 and delivery of generated reports from server device 104 to client device 102. Network 106 can also provide connectivity between server device 104 and data store 110, which may be implemented on separate storage infrastructure, enabling read and write operations for persistent data storage. In some implementations, network 106 can provide connectivity between server device 104 and external resource 108, enabling queries for literature verification, citation validation, or retrieval of external reference data. Network 106 can further provide connectivity between server device 104 and expert interface portal 118 when the portal is hosted on separate server infrastructure, enabling transmission of anonymized preliminary reports to experts and receipt of expert feedback. In some embodiments, network 106 can support various communication protocols including Transmission Control Protocol/Internet Protocol (TCP/IP) for general data transmission, Hypertext Transfer Protocol Secure (HTTPS) for web-based communications, Transport Layer Security (TLS) or Secure Sockets Layer (SSL) protocols for encrypted data transmission, File Transfer Protocol (FTP) or Secure File Transfer Protocol (SFTP) for large file uploads, Simple Mail Transfer Protocol (SMTP) for email notifications, or application-specific protocols defined through REST APIs, SOAP web services, or other interface specifications.

Server device 104 may connect to network 106 through network interface unit 170, which can be connected to system bus 174. In some embodiments, network interface unit 170 can include one or more network interface cards (NICs), wireless network adapters, cellular modems, or other network communication hardware components. Network interface unit 170 can implement physical layer connectivity using Ethernet standards such as 1 Gigabit Ethernet, 10 Gigabit Ethernet, or higher-speed standards, wireless connectivity using Wi-Fi standards such as 802.11ac or 802.11ax, or other wired or wireless communication technologies. In some implementations, network interface unit 170 may include multiple network interfaces providing redundant connectivity pathways for improved reliability and failover capabilities. It should be appreciated that network interface unit 170 may also be utilized to connect to other types of networks and remote computing systems not explicitly depicted in FIG. 1, such as cloud storage services, authentication servers, backup systems, or monitoring infrastructure. Server device 104 can also include input/output (I/O) unit 172 for receiving and processing input from a number of devices, including keyboards, mice, touch user interface display screens, or other input devices. In some embodiments, I/O unit 172 may be connected to system bus 174 and may facilitate communication with peripheral devices such as monitors for displaying administrative interfaces, printers for generating hard copies of reports, external storage devices for backup operations, or other peripheral hardware. Similarly, I/O unit 172 may provide output to display screens, enabling system administrators to monitor processing status, configure system parameters, review audit logs, or perform maintenance operations on server device 104.

As mentioned above, mass storage device 182 and RAM 178 of server device 104 can store software instructions and data. The software instructions can include operating system 186, which may include server operating systems such as Linux distributions (e.g., Ubuntu Server, Red Hat Enterprise Linux, CentOS), Microsoft Windows Server, or macOS Server. Operating system 186 can provide core functionality including process scheduling, memory management, file system operations, device driver interfaces, network stack implementations, and security mechanisms such as user authentication, access control, and firewall capabilities. In some implementations, operating system 186 may be configured with security hardening measures appropriate for handling protected health information, including encryption subsystems, audit logging capabilities, access control frameworks, and HIPAA-compliant security standards. Operating system 186 can manage allocation of CPU 168 processing time across multiple executing applications, RAM 178 memory space for active processes, and scheduling of read/write operations to mass storage device 182.

Software applications 184, when executed by CPU 168, cause server device 104 to provide the functionality of system 100 discussed throughout this document. In some embodiments, software applications 184 can include the functional modules described with reference to FIG. 2, including document processor module 112 (with file ingestion module 132 and text extraction module 134), anonymization module 114 (with PHI identification module 136 and pseudonymization module 138), AI analysis module 116 (with case manager AI module 140 and triage module 142), expert interface portal 118 (with expert communication module 144), report generator module 120 (with reconciliation module 146, de-anonymization module 148, and report formatting module 150), and feedback loop module 152. Software applications 184 can also include supporting components such as optical character recognition engines (e.g., Tesseract), PDF processing libraries, natural language processing frameworks, machine learning libraries (e.g., PyTorch, TensorFlow), web application frameworks, database drivers for accessing data store 110, API client libraries for querying external resource 108, HTML-to-PDF conversion engines, and cryptographic libraries for encryption and hashing operations. In some implementations, software applications 184 may include large language model parameters and architecture definitions including billions of numerical weight values stored in optimized binary formats, model configuration files specifying transformer architectures, tokenizer vocabularies and encoding rules, and fine-tuned model checkpoints adapted for medical document analysis tasks. Software applications 184 can implement the methods described with reference to FIGS. 3, 5, and 6, including method 200 for overall document processing workflows, method 400 for case manager prompt configuration and preliminary report generation, and method 500 for reconciliation prompt configuration and final report generation.

The hardware architecture illustrated in FIG. 7 provides the physical computing infrastructure that enables server device 104 to execute the software-implemented methods and modules described throughout this disclosure, transforming uploaded document files into anonymized preliminary reports for expert review and subsequently into court-ready final reports synthesizing expert feedback, source document verification, and professional medical-legal analysis.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for improving performance of a large language model (LLM), comprising:
training the LLM to generate medical case summaries and medical expert reports, and to identify information relevant to generation of the medical case summaries missing from .txt files, to provide a trained LLM;
receiving medical files having a plurality of file formats;
executing, using at least one processor, a script stored on non-transitory computer-readable storage, the executing including:
extracting text from the medical files to generate extracted text, including, for one of the files:
determining that a page includes fewer than a predefined threshold number of readable characters; and, based thereon,
performing optical character recognition on the page;
identifying, in the extracted text, sensitive data;
anonymizing the sensitive data to anonymize the extracted text and provide extracted, anonymized text, including replacing the sensitive data with pseudonymized representations and maintaining a cryptographic mapping structure that associates the sensitive data with corresponding pseudonymized representations, the cryptographic mapping structure stored in a data store with hash-based indexing;
combining contents of the medical files into a single . txt file using the extracted, anonymized text;
providing the .txt file to the trained LLM together with a first prompt;
determining, using the trained LLM, information missing from the .txt file;
generating, using the trained LLM, a request on a first user interface requesting submission of the information missing from the .txt file;
receiving, by the trained LLM and via the first user interface, a response to the request;
generating, by the LLM, based on the response and using the .txt file and the first prompt, an anonymized case summary that includes the pseudonymized representations;
receiving, by the trained LLM and via a second user interface, a textual comment about the anonymized case summary; and
generating a report by the trained LLM using the anonymized case summary, the textual comment, the medical files, and a second prompt, the report including the sensitive data, restored by performing hash table lookups in the cryptographic mapping structure to replace the pseudonymized representations in the anonymized case summary with corresponding original sensitive data.

2. The method of claim 1, wherein the extracting includes, for another one of the medical files:
determining that another page includes at least the predefined threshold number of readable characters; and, based thereon,
not performing optical character recognition on the other page.

3. The method of claim 1, wherein the plurality of file formats include at least two of: Portable Document Format (PDF), Extensible Markup Language (XML), JavaScript Object Notation (JSON), Digital Imaging and Communications in Medicine (DICOM), or Neuroimaging Informatics Technology Initiative (NIfTI).

4. The method of claim 3, wherein the plurality of file formats include all of PDF, XML, JSON, DICOM, and NIfTI.

5. The method of claim 1, wherein the information missing from the . txt file is determined based on a triage classification of the medical files that identifies, in the medical files, potential standard-of-care deviations, procedural errors, or diagnostic failures.

6. The method of claim 1, wherein the anonymized case summary includes an indication of potential standard-of-care deviations, procedural errors, or diagnostic failures identified in the medical files, and a confidence level associated with each identified potential standard-of-care deviation, procedural error, or diagnostic failure.

7. The method of claim 1, wherein the response to the request includes another medical file.

8. The method of claim 1, wherein the first prompt and the second prompt are different from each other further, the method further comprising:
storing the first prompt and the second prompt in a data storage;
retrieving the first prompt from the data storage to provide the first prompt to the trained LLM; and
retrieving the second prompt from the data storage to provide the second prompt to the trained LLM.

9. The method of claim 1, wherein generating the report includes extracting the sensitive data from the medical files.

10. The method of claim 1, wherein the report includes other information provided in the textual comment that was not provided in the medical files.

11. A system for improving performance of a large language model (LLM), comprising:
a server device;
a first display device;
at least one processor; and
non-transitory computer-readable storage having stored thereon instructions which, when executed by the at least one processor, causes the system to:
train the LLM to generate medical case summaries and medical expert reports, and to identify information relevant to generation of the medical case summaries missing from . txt files, to provide a trained LLM;
receive, by the server device, medical files having a plurality of file formats;
extract text from the medical files to generate extracted text, including, for one of the files:
determine that a page includes fewer than a predefined threshold number of readable characters; and, based thereon,
perform optical character recognition on the page;
identify, in the extracted text, sensitive data;
anonymize the sensitive data to anonymize the extracted text and provide extracted, anonymized text, including replacing the sensitive data with pseudonymized representations and maintaining a cryptographic mapping structure that associates the sensitive data with corresponding pseudonymized representations, the cryptographic mapping structure stored in a data store with hash-based indexing;
combine contents of the medical files into a single . txt file using the extracted, anonymized text;
provide, by the server device, the . txt file to the trained LLM together with a first prompt;
determine, using the trained LLM, information missing from the . txt file;
generate, using the trained LLM, a request on a first user interface on the first display device, the request requesting submission of the information missing from the . txt file;
receive, by the trained LLM and via the first user interface, a response to the request;
generate, by the LLM, based on the response and using the . txt file and the first prompt, an anonymized case summary that includes the pseudonymized representations;
receive, by the trained LLM and via a second user interface on a second display device of a computing device, a textual comment about the anonymized case summary; and
generate a report by the trained LLM using the anonymized case summary, the textual comment, the medical files, and a second prompt, the report including the sensitive data, restored by performing hash table lookups in the cryptographic mapping structure to replace the pseudonymized representations in the anonymized case summary with corresponding original sensitive data.

12. The system of claim 11, wherein to extract the text includes, for another one of the medical files:
determine that another page includes at least the predefined threshold number of readable characters; and, based thereon,
not perform optical character recognition on the other page.

13. The system of claim 11, wherein the plurality of file formats include at least two of: Portable Document Format (PDF), Extensible Markup Language (XML), JavaScript Object Notation (JSON), Digital Imaging and Communications in Medicine (DICOM), or Neuroimaging Informatics Technology Initiative (NIfTI).

14. The system of claim 13, wherein the plurality of file formats include all of PDF, XML, JSON, DICOM, and NIfTI.

15. The system of claim 11, wherein the information missing from the . txt file is determined based on a triage classification of the medical files that identifies, in the medical files, potential standard-of-care deviations, procedural errors, or diagnostic failures.

16. The system of claim 11, wherein the anonymized case summary includes an indication of potential standard-of-care deviations, procedural errors, or diagnostic failures identified in the medical files, and a confidence level associated with each identified potential standard-of-care deviation, procedural error, or diagnostic failure.

17. The system of claim 11, wherein the response to the request includes another medical file.

18. The system of claim 11,
wherein the first prompt and the second prompt are different from each other, and
wherein the non-transitory computer-readable storage stores further instructions which, when executed by the at least one processor, causes the system to:
store the first prompt and the second prompt in a data storage;
retrieve the first prompt from the data storage in response to input provided via a third user interface on the first display device to provide the first prompt to the trained LLM; and
retrieve the second prompt from the data storage in response to input provided via a fourth user interface on the first display device to provide the second prompt to the trained LLM.

19. The system of claim 11, wherein to generate the report includes to extract the sensitive data from the medical files.

20. The system of claim 11, wherein the report includes other information provided in the textual comment that was not provided in the medical files.
